(19) United States
(12) Patent Application Publication
(10) Pub. No.: US 2021/0010505 A1
(43) Pub. Date: Jan. 14, 2021

(54) CONNECTION STRUCTURE OF BOLT AND NUT OF ASYMMETRIC BIDIRECTIONAL TAPERED THREAD IN OLIVE-LIKE SHAPE

(71) Applicant: AMICUS VERITATIS MACHINERY CO., LTD., TAIZHOU (CN)

(72) Inventor: Yihua YOU, TAIZHOU (CN)

(21) Appl. No.: 17/034,391

(22) Filed: Sep. 28, 2020

Related U.S. Application Data
(63) Continuation of application No. PCT/CN2019/081383, filed on Apr. 4, 2019.

(30) Foreign Application Priority Data
Apr. 7, 2018 (CN) 201810303107.1

(51) Int. Cl. F16B 33/02; F16B 35/04; F16B 39/30

(52) U.S. Cl. CPC F16B 33/02; F16B 39/30; F16B 35/04

(57) ABSTRACT

The present invention belongs to the field of general technology of device, and particularly relates a connection structure of a bolt and a nut of an asymmetric bidirectional tapered thread in an olive-like shape, which solves the problems such as poor self-positioning and self-locking performance of the existing screw thread. The connection structure is characterized in that an external thread (9) is a bidirectional tapered hole (41) (non-entity space) in an internal surface of a cylindrical body (2); an external thread (9) is a bidirectional truncated cone body (71) (material entity) on an external surface of a columnar body (3); and a complete unit thread is a helical bidirectional tapered body in an olive-like shape (93) in which a left taper (95) is greater than and/or less than a right taper (96).

### CROSS-REFERENCE TO RELATED APPLICATIONS

This application is a continuation of International Patent Application No. PCT/CN2019/081383, filed on Apr. 4, 2019, entitled “Connection Structure of Bolt and Nut of Asymmetric Bidirectional Tapered Thread in Olive-like shape” which claims priority to China Patent Application No. 201810303107.1, filed on Apr. 7, 2018. The contents of these identified applications are hereby incorporated by references.

### TECHNICAL FIELD

The present invention belongs to the field of general technology of device, and more particularly relates to a connection structure of a bolt and a nut of an asymmetric bidirectional tapered thread in an olive-like shape and a traditional screw thread (hereinafter referred to as a connection structure of a bolt and a nut of a bidirectional tapered thread).

### BACKGROUND OF THE INVENTION

The invention of thread has a profound impact on the progress of human society. Thread is one of the most basic industrial technologies. It is not a specific product, but a key generic technology in the industry. It has the technical performance that must be embodied by specific products as application carriers, and is widely applied in various industries. The existing thread technology has high standardization level, mature technical theory and long-term practical application. It is a fastening thread when used for fastening, a sealing thread when used for sealing, and a transmission thread when used for transmission. According to the thread terminology of national standards, the “thread” refers to thread bodies having the same tooth profile and continuously protruding along a helical line on a cylindrical or conical surface; and the “tooth body” refers to a material entity between adjacent flanks. This is also the definition of thread under global consensus.

The modern thread began in 1841 with British Whitworth thread. According to theory of modern thread technology, the basic condition for self-locking of the thread is that an equivalent friction angle shall not be smaller than a helical rise angle. This is an understanding for the thread technology in modern thread based on a technical principle—“principle of inclined plane”, which has become an important theoretical basis of the modern thread technology. Simon Stevin was the first to explain the principle of inclined plane theoretically. He has researched and discovered the parallelogram law for balancing conditions and force composition of objects on the inclined plane. In 1586, he put forward the famous law of inclined plane that the gravity of an object placed on the inclined plane in the direction of inclined plane is proportional to the sine of inclination angle. The inclined plane refers to a smooth plane inclined to the horizontal plane; the helix is a deformation of the “inclined plane”; the thread is like an inclined plane wrapped around the cylinder, and the flatter the inclined plane is, the greater the mechanical advantage is (see FIG. 14) (Jingshan Yang and Xiuya Wang, Discussion on the Principle of Screws, Disquisitiones Arithmeticae of Gauss).

The “principle of inclined plane” of the modern thread is an inclined plane slider model (see FIG. 15) which is established based on the law of inclined plane. It is believed that the thread pair meets the requirements of self-locking when a thread rise angle is less than or equal to the equivalent friction angle under the condition of little change of static load and temperature. The thread rise angle (see FIG. 16), also known as a thread lead angle, is an angle between a tangent line of a helical line on a pitch-diameter cylinder and a plane perpendicular to a thread axis; and the angle affects the self-locking and anti-loosening of the thread. The equivalent friction angle is a corresponding friction angle when different friction forms are finally transformed into the most common inclined plane slider form. Generally, in the inclined plane slider model, when the inclined plane is inclined to a certain angle, the friction force of the slider at this time is exactly equal to the component of gravity along the inclined plane; the object is just in a state of force balance at this time; and the inclination angle of the inclined plane at this time is called the equivalent friction angle.

American engineers invented the wedge thread in the middle of last century; and the technical principle of the wedge thread still follows the “principle of inclined plane”. The invention of the wedge thread was inspired by the “wooden wedge”. Specifically, the wedge thread has a structure that a wedge-shaped inclined plane forming an angle of 25°-30° with the thread axis is located at the root of teeth of internal threads (i.e., nut threads) of triangular threads (commonly known as common threads); and a wedge-shaped inclined plane of 30° is adopted in engineering practice. For a long time, people have studied and solved the anti-loosening and other problems of the thread from the technical level and technical direction of thread profile angle. The wedge thread technology is also a specific application of the inclined wedge technology without exception.

However, the existing threads have the problems of low connection strength, weak self-positioning ability, poor self-locking performance, low bearing capacity, poor stability, poor compatibility, poor reusability, high temperature and low temperature and the like. Typically, bolts or nuts using the modern thread technology generally have the defect of easy loosening. With the frequent vibration or shaking of equipment, the bolts and the nuts become loose or even fall off, which easily causes safety accidents in serious cases.

### SUMMARY OF THE INVENTION

Any technical theory has theoretical hypothesis background; and the thread is not an exception. With the development of science and technology, the damage to connection is not simple linear load, static or room temperature environment; and linear load, nonlinear load and even the superposition of the two cause more complex load damaging conditions and complex application conditions. Based on such recognition, the object of the present invention is to provide a connection structure of a bolt and a nut of a bidirectional tapered thread with reasonable design, simple structure, and excellent connection performance and locking performance with respect to the above problems.

In order to achieve the above objective, the present invention adopts the following technical solution. The connection structure of the bolt and the nut of the bidirectional tapered thread is a thread connection pair that is composed of an internal thread of an asymmetric bidirectional tapered thread and an external thread of the asymmetric bidirectional tapered thread. It is a special thread pair technology that combines technical characteristics of a cone pair and a helical movement. The bidirectional tapered thread is a screw thread technology that combines technical characteristics of a bidirectional tapered body and a helical structure. The bidirectional tapered body is composed of two unidirectional tapered bodies, that is, the bidirectional tapered body is bidirectionally composed of two unidirectional tapered bodies which are opposite in directions of a left taper and a right taper and different in taper sizes of the left taper and the right taper. The external thread is formed in a such a way that the bidirectional tapered body is helically distributed on the external surface of the columnar body and/or the internal thread is formed in such a way that the bidirectional tapered body is helically distributed on the internal surface of the cylindrical body, and its complete unit thread is a special asymmetric bidirectional tapered geometry in an olive-like shape, with a large middle and two small ends, and with the left taper greater than the right taper and/or the left taper less than the right taper.

According to the connection structure of the bolt and the nut of the bidirectional tapered thread, the asymmetric bidirectional tapered thread in an olive-like shape includes two forms, that is, one form in which the left taper is greater than the right taper and the other one in which the left taper is less than the right taper. The definition of the asymmetric bidirectional tapered thread in an olive-like shape may be expressed as follows: “asymmetric bidirectional tapered holes (or asymmetric bidirectional truncated cone bodies) which have defined left taper and right taper as well as are opposite in directions of the left taper and the right taper and different in taper size of the left taper and the right taper and special bidirectional tapered geometries in an olive-like shape that are continuously and/or non-continuously distributed along the helical line and have a large middle and two small ends respectively are arranged on a columnar surface or a conical surface”. Due to manufacturing reasons, heads and tails of the asymmetric bidirectional tapered threads may be incomplete bidirectional tapered geometries. By virtue of the mutual thread fit, the thread technology has changed from the cohesion relationship between the internal thread and the external thread in the modern thread to the cohesion relationship between the internal thread and the external thread in the bidirectional tapered thread.

The connection structure of the bolt and the nut of the bidirectional tapered thread includes a bidirectional truncated cone body helically distributed on the external surface of the columnar body and a bidirectional tapered hole helically distributed on the internal surface of the cylindrical body, that is, includes an external thread and an internal thread in mutual thread fit, wherein the internal thread exists in the form of the special helical tapered hole and a “non-entity space”, and the external thread exists in the form of the bidirectional helical truncated cone body and a “material entity”. The non-entity space refers to a space environment capable of accommodating the above-mentioned material entity. The internal thread is a housing member, and the external thread is a housed member. The threads work in such a state that the internal thread, that is, the bidirectional tapered hole, and the external thread, that is, the bidirectional truncated cone body, are fitted together by screwing the two bidirectional tapered geometries pitch by pitch, and the internal thread is cohered with the external thread till one side bears the load bidirectionally or both the left side and the right side bear the load bidirectionally at the same time or till the external thread and the internal thread are in interference fit. Whether the two sides bear bidirectional load at the same time is related to the actual working conditions in the application field, that is, the bidirectional tapered hole houses and is fitted with the bidirectional truncated cone body pitch by pitch, i.e., the internal thread is fitted with the corresponding external thread pitch by pitch.

The thread connection pair is characterized in that a helical external conical surface and a helical internal conical surface are cooperated to constitute a cone pair to form a thread pair. The external conical surface of the external cone and the internal conical surface of the internal cone of the bidirectional tapered thread both are bidirectional conical surface. When the thread connection pair is formed between the bidirectional tapered thread, a joint surface of the internal conical surface and the external conical surface is used as a bearing surface, that is, the conical surface is used as the bearing surface to achieve the connecting performance. Self-locking property, self-positioning property, reusability, fatigue resistance and other capabilities of the thread pair mainly depend on a conical surface and the taper size of the cone pair constituting the connection structure of the bolt and the nut of the bidirectional tapered thread, that is, the conical surfaces and the taper sizes thereof of the internal thread and the external thread. The connection structure of the bolt and the nut of the bidirectional tapered thread is a non-form thread.

Different from that the principle of inclined plane of the existing thread which shows a unidirectional force distributed on the inclined plane as well as a cohesion relationship between the internal tooth bodies and the external tooth bodies of the internal thread and the external thread, the thread body, that is, the bidirectional tapered body, of the connection structure of the bolt and the nut of the bidirectional tapered thread is composed of two plain lines of the cone body in two directions (i.e. bidirectional state) when viewed from any cross section of the single tapered body distributed on either left or right side along the cone axis. The plain line is the intersection line of the conical surfaces and a plane through which the cone axis passes through. The cone principle of the connection structure of the bolt and the nut of the bidirectional tapered thread shows an axial force and a counter-axial force, both of which are combined by bidirectional forces, wherein the axial force and the corresponding counter-axial force are opposite to each other. The internal thread and the external thread are in a cohesion relationship. Namely, the thread pair is formed by cohering the external thread with the internal thread, i.e., the tapered hole (internal cone body) is cohered with the corresponding tapered cone body (external cone body) pitch by pitch till the self-positioning is realized by cohesion fit or till the self-locking is realized by interference contact. Namely, the self-locking or self-positioning of the internal cone body and the external cone body is realized by radially cohering the tapered hole and the truncated cone body to realize the self-locking or self-positioning of the thread pair, rather than the thread connection pair, composed of the internal thread and the external thread in the traditional thread, which realizes its connection performance by mutual abutment between the tooth bodies.

A self-locking force will arise when the cohesion process between the internal thread and the external thread reaches certain conditions. The self-locking force is generated by a pressure produced between an axial force of the internal cone and a counter-axial force of the external cone. Namely, when the internal cone and the external cone form the cone pair, the internal conical surface of the internal cone body is cohered with the external conical surface of the external cone body; and the internal conical surface is in close contact with the external conical surface. The axial force of the internal cone and the counter-axial force of the external cone are concepts of forces unique to the bidirectional tapered thread technology, i.e., the cone pair technology, in the present invention.

The internal cone body exists in a form similar to a shaft sleeve, and generates the axial force pointing to or pressing toward the cone axis under the action of an external load. The axial force is bidirectionally combined by a pair of centripetal forces which are distributed in mirror image with the cone axis as a center and are respectively perpendicular to two plain lines of the cone body; i.e., the axial force passes through the cross section of the cone axis and is composed of two centripetal forces which are bidirectionally distributed on two sides of the cone axis in mirror image with the cone axis being the center, are respectively perpendicular to the two plain lines of the cone body, and point to or press toward a common point of the cone axis; and the axial force passes through a cross section of a thread axis and is composed of two centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The axial force is densely distributed on the cone axis and/or the thread axis in an axial and circumferential manner, and corresponds to an axial force angle, wherein the axial force angle is formed by an angle between two centripetal forces forming the axial force and depends on the taper of the cone body, i.e., the taper angle.

The external cone body exists in a form similar to a shaft, has relatively strong ability to absorb various external loads, and generates a counter-axial force opposite to each axial force of the internal cone body. The counter-axial force is bidirectionally combined by a pair of counter-centripetal forces which are distributed in mirror image with the cone axis as the center and are respectively perpendicular to the two plain lines of the cone body; i.e., the counter-axial force passes through the cross section of the cone axis and is composed of two counter-centripetal forces which are bidirectionally distributed on two sides of the cone axis in mirror image with the cone axis as the center, are respectively perpendicular to the two plain lines of the cone body, and point to or press toward the common point of the cone axis; and the counter-axial force passes through the cross section of the thread axis and is composed of two counter-centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The counter-axial force is densely distributed on the cone axis and/or the thread axis in the axial and circumferential manner, and corresponds to a counter-axial force angle, wherein the counter-axial force angle is formed by an angle between the two counter-centripetal forces forming the counter-axial force and depends on the taper of the cone body, i.e., the taper angle.

The axial force and the counter-axial force start to be generated when the internal cone and the external cone of the cone pair are in effective contact, i.e., a pair of corresponding and opposite axial force and counter-axial force always exist during the effective contact of the internal cone and the external cone of the cone pair. The axial force and the counter-axial force are bidirectional forces bidirectionally distributed in mirror image with the cone axis and/or the thread axis as the center, rather than unidirectional forces. The cone axis and the thread axis are coincident axes, i.e., the same axis and/or approximately the same axis. The counter-axial force and the axial force are reversely collinear and/or approximately reversely collinear when the cone body and the helical structure are combined into the thread and form the thread pair. The internal cone and the external cone are cohered till interference is achieved, so the axial force and the counter-axial force generate a pressure on the contact surface between the internal conical surface and the external conical surface and are densely and uniformly distributed on the contact surface between the internal conical surface and the external conical surface axially and circumferentially. When the cohesion movement of the internal cone and the external cone continues till the cone pair reaches the pressure generated by interference fit to combine the internal cone with the external cone, i.e., the pressure enables the internal cone body to be cohered with the external cone body to form a similar integral structure and will not cause the internal cone body and the external cone body to separate from each other under the action of gravity due to arbitrary changes in a direction of a body position of the similar integral structure after the external force caused by the pressure disappears. The cone pair generates self-locking, which means that the thread pair generates self-locking. The self-locking performance has a certain degree of resistance to other external loads which may cause the internal cone body and the external cone body to separate from each other except gravity. The cone pair also has the self-positioning performance which enables the internal cone and the external cone to be fitted with each other. However, not any axial force angle and/or counter-axial force angle may enable the cone pair to produce self-locking and self-positioning.

When the axial force angle and/or the counter-axial force angle is less than 180° and greater than 127°, the cone pair has the self-locking performance. When the axial force angle and/or the counter-axial force angle is infinitely close to 180°, the cone pair has the best self-locking performance and the weakest axial bearing capacity. When the axial force angle and/or the counter-axial force angle is equal to and/or less than 127° and greater than 0°, the cone pair is in a range of weak self-locking performance and/or no self-locking performance. When the axial force angle and/or the counter-axial force angle tends to change in a direction infinitely close to 0°, the self-locking performance of the cone pair changes in a direction of attenuation until the cone pair completely has no self-locking ability; and the axial bearing capacity changes in a direction of enhancement until the axial bearing capacity is the strongest.

When the axial force angle and/or the counter-axial force angle is less than 180° and greater than 127°, the cone pair is in a strong self-positioning state, and the strong self-positioning of the internal cone body and the external cone body is easily achieved. When the axial force angle and/or the counter-axial force angle is infinitely close to 180°, the internal cone body and the external cone body of the cone pair have the strongest self-positioning ability. When the axial force angle and/or the counter-axial force angle is equal to and/or less than 127° and greater than 0°, the cone pair is in a weak self-positioning state. When the axial force angle and/or the counter-axial force angle tends to change in the direction infinitely close to 0°, the mutual self-positioning ability of the internal and external cone bodies of the cone pair changes in the direction of attenuation until the cone pair is close to have has no self-positioning ability at all.

Compared with the technology with the housing and housed relationship of irreversible one-sided bidirectional housing that the unidirectional tapered thread of a single cone body invented by the applicant before which can only bear the load by one side of the conical surface, the thread connection pair of the bidirectional tapered thread technology of the present disclosure allows the reversible left and right-sided bidirectional housing of the bidirectional tapered threads of double cone bodies, enabling the left side and/or the right side of the conical surface to bear the load, and/or the left conical surface and the right conical surface to respectively bear the load, and/or the left conical surface and the right conical surface to simultaneously bear the load bidirectionally, and further limiting a disordered degree of freedom between the tapered hole and the truncated cone body; and the helical movement enables the connection structure of the bolt and the nut of the bidirectional tapered thread to obtain a necessary ordered degree of freedom, thereby effectively combining the technical characteristics of the cone pair and the thread pair to form a brand-new thread technology.

When the connection structure of the bolt and the nut of the bidirectional tapered thread is used, a bidirectional truncated cone body conical surface of the external thread of the bidirectional tapered thread matches with a bidirectional tapered hole conical surface of the internal thread of the bidirectional tapered thread.

The bidirectional tapered body, that is, the truncated cone body and/or the tapered body, of the cone pair of the connection structure of the bolt and the nut of the bidirectional tapered thread may achieve the self-locking property and/or the self-positioning property of the thread connection pair. The connection structure of the bolt and the nut of the bidirectional tapered thread may have self-locking and self-positioning properties as long as the internal cone and the external cone must reach a certain taper or a certain taper angle. The tapers include left tapers and right tapers of the internal thread body and the external thread body, wherein the left tapers correspond to the left taper angle, that is, the first taper angle α1, and the right tapers correspond to the right taper angle, that is, the second taper angle α2. When the left taper is greater than the right taper, preferably, the first taper angle α1 is greater than 0° and less than 53°, preferably, the first taper angle α1 takes a value in a range from 2° to 40°. For individual special fields, preferably, the first taper angle α1 is greater than or equal to 53° and less than 180°, preferably, the first taper angle α1 takes a value in a range from 53° to 90°; and preferably, the second taper angle α2 is greater than 0° and less than 53°, preferably, the second taper angle α2 takes a value in a range from 2° to 40°.

When the right taper is greater than the left taper, preferably, the first taper angle α1 is greater than 0° and less than 53°, preferably, the first taper angle α1 takes a value in a range from 2° to 40°; and preferably, the second taper angle α2 is greater than 0° and less than 53°, preferably, the second taper angle α2 takes a value in a range from 2° to 40°. For individual special fields, preferably, the second taper angle α2 is greater than or equal to 53° and less than 180°, preferably, the second taper angle α2 takes a value in a range from 53° to 90°.

The above-mentioned individual special fields refer to the application fields of thread connection such as transmission connection with low requirements on self-locking performance or even without self-locking performance and/or with low requirements on self-positioning performance and/or with high requirements on axial bearing capacity and/or with indispensable anti-locking measures.

According to the connection structure of the bolt and the nut of the bidirectional tapered thread, the external thread is arranged on the external surface of the columnar body to form a bolt, wherein the columnar body is provided with a screw body, a helically distributed truncated cone body including an asymmetric bidirectional truncated cone body is disposed on the external surface of the screw body, and the columnar body may be solid or hollow, including columnar workpieces and objects mid/or non-columnar workpieces and objects that need to be machined with screw threads on their external surfaces. The external surfaces include columnar surfaces, non-columnar surfaces such as conical surfaces, and external surfaces of other geometric shapes.

According to the connection structure of the bolt and the nut of the bidirectional tapered thread, the asymmetric bidirectional truncated cone body, that is, the external thread, is formed by symmetrically and oppositely joining lower bottom surfaces of the two truncated cone body with the same lower bottom surfaces and the same upper top surfaces and different heights in a helical shape, and upper top surfaces are disposed on two ends of the bidirectional truncated cone bodies to form the asymmetric bidirectional tapered thread in an olive-like shape, and the process includes that the upper top surfaces are respectively fitted with upper top surfaces of adjacent bidirectional truncated cone bodies and/or respectively fitted with upper top surfaces of adjacent bidirectional truncated cone bodies in a helical shape. The external thread includes a first helical conical surface of the truncated cone body, a second helical conical surface of the truncated cone body, and an external helical line. Within a cross section passing through the thread axis, the complete single-pitch asymmetric bidirectional tapered external thread is a special bidirectional tapered geometry in an olive-like shape, with a large middle and two small ends. The asymmetric bidirectional truncated cone body includes a bidirectional truncated cone body conical surface, wherein an included angle between two plain lines of a left conical surface, that is, the first helical conical surface of the truncated cone body, is a first taper angle α1, and the first helical conical surface of the truncated cone body forms the left taper and is in a leftward distribution; and an included angle α2 between two plain lines of a right conical surface, that is, the second helical conical surface of the truncated cone body, is a second taper angle α2, and the second helical conical surface of the truncated cone body forms the right taper and is in a rightward distribution. Taper directions corresponding to the first taper angle α1 and the second taper angle α2 are opposite, and the plain lines are intersecting lines of the conical surface with the plane passing through the cone axis. A shape formed by the first helical conical surface of the truncated cone body and the second helical conical surface of the truncated cone body of the bidirectional truncated cone body is the same as a shape of an external helical lateral surface of a rotary body, wherein the rotary body is formed by two inclined sides of a right-angled trapezoid union when the right-angled trapezoid union axially moves at a constant speed along a central axis of the columnar body while circumferentially rotating at a constant speed with right-angled sides of the right-angled trapezoid union as a rotation center, wherein the right-angled trapezoid union is formed by symmetrically and oppositely joining lower bottom sides of two right-angled trapezoids with the same lower bottom sides and the same upper bottom sides but different right-angled sides, wherein the right-angled trapezoids coincide with the central axis of the columnar body. The right-angled trapezoid union refers to a special geometry in which the lower bottom sides of the two right-angled trapezoids with the same lower bottom sides and the same upper bottom sides but different right-angled sides are symmetrically and oppositely joined and the upper bottom sides thereof are respectively located at two ends of the right-angled trapezoid union.

According to the connection structure of the bolt and the nut of the bidirectional tapered thread, the internal thread is arranged on the internal surface of the cylindrical body to form a bolt, wherein a helically distributed tapered hole including an asymmetric bidirectional tapered hole is disposed on the internal surface of the nut body, the tapered hole includes an asymmetric bidirectional tapered hole, the cylindrical body includes cylindrical workpieces and objects and/or non-cylindrical workpieces and objects that need to be machined with internal threads on their internal surfaces. The internal surfaces include columnar surfaces, non-columnar surfaces such as conical surfaces, and internal surfaces of other geometric shapes.

According to the connection structure of the bolt and the nut of the bidirectional tapered thread, the asymmetric bidirectional tapered hole, that is, the internal thread, is characterized by being formed by symmetrically and oppositely joining lower bottom surfaces of the two tapered holes with the same lower bottom surfaces and the same upper top surfaces and different heights in a helical shape, and upper top surfaces are disposed on two ends of the bidirectional tapered hole to form the asymmetric bidirectional tapered thread in an olive-like shape, and the process includes that the upper top surfaces are respectively fitted with upper top surfaces of adjacent bidirectional tapered holes and/or respectively fitted with upper top surfaces of adjacent bidirectional tapered holes in a helical shape. The internal thread includes a first helical conical surface of the tapered hole, a second helical conical surface of the tapered hole, and an internal helical line. Within a cross section passing through the thread axis, the complete single-pitch asymmetric bidirectional tapered internal thread is a special bidirectional tapered geometry in an olive-like shape, with a large middle and two small ends. The asymmetric bidirectional tapered hole includes a bidirectional tapered hole conical surface, wherein an included angle between two plain lines of a left conical surface, that is, the first helical conical surface of the tapered hole, is a first taper angle α1, and the first helical conical surface of the tapered hole forms the left taper and is in a leftward distribution; and an included angle between two plain lines of a right conical surface, that is, the second helical conical surface of the tapered hole, is a second taper angle α2, and the second helical conical surface of the tapered hole forms the right taper and is in a rightward distribution. Taper directions corresponding to the first taper angle α1 and the second taper angle α2 are opposite, and the plain lines are intersecting lines of the conical surface with the plane passing through the cone axis. A shape formed by the first helical conical surface of the tapered hole and the second helical conical surface of the tapered hole of the bidirectional tapered hole is the same as a shape of an external helical lateral surface of a rotary body, wherein the rotary body is formed by two inclined sides of a right-angled trapezoid union when the right-angled trapezoid union axially moves at a constant speed along a central axis of the cylindrical body while circumferentially rotating at a constant speed with right-angled sides of the right-angled trapezoid union as a rotation center, wherein the right-angled trapezoid union is formed by symmetrically and oppositely joining lower bottom sides of two right-angled trapezoids with the same lower bottom sides and the same upper bottom sides but different right-angled sides, wherein the right-angled trapezoids coincide with the central axis of the cylindrical body. The right-angled trapezoid union refers to a special geometry in which the lower bottom sides of the two right-angled trapezoids with the same lower bottom sides and the same upper bottom sides but different right-angled sides are symmetrically and oppositely joined and the upper bottom sides thereof are respectively located at two ends of the right-angled trapezoid union.

When the connection structure of the bolt and the nut of the bidirectional tapered thread operates, the connection structure of the bolt and the nut of the bidirectional tapered thread is in a relationship including a rigid connection and a non-rigid connection with a workpiece. The rigid connection means that a bearing surface of the nut and a bearing surface of the workpiece serve as bearing surfaces each other, and includes single-nut and double-nut structural forms. The non-rigid connection means that end surfaces at opposite sides of double nuts serve as bearing surfaces each other and/or the end surfaces of the opposite sides of the two nuts indirectly serve as bearing surfaces each other due to a gasket disposed therebetween. The non-rigid connection is mainly applied to a non-rigid material or a non-rigid connecting workpiece such as a transmission member or application fields in which demands are met by mounting the double nuts. The workpiece refers to a connected object including the workpiece, and the gasket refers to a spacer including the gasket

According to the connection structure of the bolt and the nut of the bidirectional tapered thread, when a connection structure of a bolt and double nuts is adopted and is in a relationship of a rigid connection with a fastened workpiece, thread working bearing surfaces are different. When the cylindrical body is located at the left side of the fastened workpiece, that is, a left end surface of the fastened workpiece and a right end surface of the cylindrical body, that is, a left nut body, are locking bearing surfaces of the left nut body and the fastened workpiece, right helical conical surfaces, that is, a second helical conical surface of the tapered hole and a second helical conical surface of the truncated cone body, of bidirectional tapered threads of the left nut body and the columnar body, that is, the screw body, that is, the bolt, are bearing surfaces of the tapered thread, and the second helical conical surface of the tapered hole and the second helical conical surface of the truncated cone body serve as bearing surfaces each other. When the cylindrical body is located at the right side of the fastened workpiece, that is, a right end surface of the fastened workpiece and a left end surface of the cylindrical body, that is, a right nut body, are locking bearing surfaces of the right nut body and the fastened workpiece, left helical conical surfaces, that is, a first helical conical surface of the tapered hole and a first helical conical surface of the truncated cone body, of bidirectional tapered threads of the right nut body and the columnar body, that is, the screw body, that is, the bolt, are bearing surfaces of the tapered thread, and the first helical conical surface of the tapered hole and the first helical conical surface of the truncated cone body serve as bearing surfaces each other.

According to the connection structure of the bolt and the nut of the bidirectional tapered thread, when a connection structure of a bolt and a single nut is adopted and is in a relationship of a rigid connection with a fastened workpiece, and a hexagonal head of the bolt is located at the left side, the cylindrical body, that is, a nut body, that is, the single nut, is located at the right side of the fastened workpiece. When the connection structure of the bolt and the single nut operates, a right end surface of the workpiece and a left end surface of the nut body are locking bearing surfaces of the nut body and the fastened workpiece, and left helical conical surfaces, that is, a first helical conical surface of the tapered hole and a first helical conical surface of the truncated cone body, of bidirectional tapered threads of the nut body and the columnar body, that is, the screw body, that is, the bolt, are bearing surfaces of the tapered thread, and the first helical conical surface of the tapered hole and the first helical conical surface of the truncated cone body serve as bearing surfaces each other. When the hexagonal head of the bolt is located at the right side, the cylindrical body, that is, the nut body, that is, the single nut, is located at the left side of the fastened workpiece. When the connection structure of the bolt and the single nut operates, a left end surface of the workpiece and a right end surface of the nut body are locking bearing surfaces of the nut body and the fastened workpiece, and right helical conical surfaces, that is, a second helical conical surface of the tapered hole and a second helical conical surface of the truncated cone body, of the bidirectional tapered threads of the nut body and the columnar body, that is, the screw body, that is, the bolt, are bearing surfaces of the tapered thread, and the second helical conical surface of the tapered hole and the second helical conical surface of the truncated cone body serve as bearing surfaces each other.

According to the connection structure of the bolt and the nut of the bidirectional tapered thread, when the connection structure of the bolt and the double nuts is adopted and is in a relationship of non-rigid connection with a fastened workpiece, thread working bearing surfaces, that is, bearing surfaces of the tapered thread, are different. The cylindrical body includes a left nut body and a right nut body, and a right end surface of the left nut body and a left end surface of the right nut body are oppositely in direct contact and serve as locking bearing surfaces each other. When the right end surface of the left nut body is the locking bearing surface, right helical conical surfaces, that is, a second helical conical surface of the tapered hole and a second helical conical surface of the truncated cone body, of bidirectional tapered threads of the left nut body and the columnar body, that is, the screw body, that is, the bolt, are bearing surfaces of the tapered thread, and the second helical conical surface of the tapered hole and the second helical conical surface of the truncated cone body serve as bearing surfaces each other. When the left end surface of the right nut body is the locking bearing surface, left helical conical surfaces, that is, a first helical conical surface of the tapered hole and a first helical conical surface of the truncated cone body, of bidirectional tapered threads of the right nut body and the columnar body, that is, the screw body, that is, the bolt, are bearing surfaces of the tapered thread, and the first helical conical surface of the tapered hole and the first helical conical surface of the truncated cone body serve as bearing surfaces each other.

According to the connection structure of the bolt and the nut of the bidirectional tapered thread, when the connection structure of the bolt and the double nuts is adopted and is in a relationship of a non-rigid connection with a fastened workpiece, thread working bearing surfaces, that is, bearing surfaces of the tapered thread, are different. The cylindrical body includes a left nut body and a right nut body, a spacer such as a gasket is provided between the two cylindrical bodies, that is, the left nut body and the right nut body, and a right end surface of the left nut body and a left end surface of the right nut body are oppositely in indirect contact by the gasket so as to indirectly serve as locking bearing surfaces each other. When the cylindrical body is located at the left side, that is, the left side surface of the gasket, and the right end surface of the left nut body is the locking bearing surface of the left nut body, right helical conical surfaces, that is, a second helical conical surface of the tapered hole and a second helical conical surface of the truncated cone body, of bidirectional tapered threads of the left nut body and the columnar body, that is, the screw body, that is, the bolt. are bearing surfaces of the tapered thread, and the second helical conical surface of the tapered hole and the second helical conical surface of the truncated cone body serve as bearing surfaces each other. When the cylindrical body is located at the right side, that is, the right side surface of the gasket, and the left end surface of the right nut body is the locking bearing surface of the right nut body, left helical conical surfaces, that is, a first helical conical surface of the tapered hole and a first helical conical surface of the truncated cone body, of bidirectional tapered threads of the right nut body and the columnar body, that is, the screw body, that is, the bolt, are bearing surfaces of the tapered thread, and the first helical conical surface of the tapered hole and the first helical conical surface of the truncated cone body serve as bearing surfaces each other.

According to the connection structure of the bolt and the nut of the bidirectional tapered thread, when the connection structure of the bolt and the double nuts is adopted and is in a relationship of a non-rigid connection with a fastened workpiece, and a cylindrical body located at the inner side, that is, a nut body adjacent to the fastened workpiece, has been effectively combined with a columnar body, that is, a screw body, that is, the bolt, i.e., an internal thread and an external thread forming a thread connection pair are effectively cohered together, a cylindrical body located at the outer side, that is, a nut body not adjacent to the fastened workpiece, may keep unchanged and/or may be removed with one nut being retained according to the application condition (such as application fields in which there are requirements on light weight of equipment or it is unnecessary to guarantee the reliability of a connection technology by double nuts), and the removed nut body is only used as a mounting process nut, rather than a connecting nut. An internal thread of the mounting process nut may be produced from the bidirectional tapered thread and may further adopt a nut body produced from a unidirectional tapered thread and other non-tapered threads, including a triangular thread, a trapezoidal thread and a zigzagging thread, capable of engaging with the tapered thread. On the premise that the reliability of a connection technology is guaranteed, the tapered thread connection pair is a closed-loop fastening technical system, that is, after the internal thread and the external thread of the tapered thread connection pair are effectively cohered together, the tapered thread connection pair will form an independent technical system so as to be capable of guaranteeing the technical effectiveness of a connection technical system without depending on a third-party technology, that is, the effectiveness of the tapered thread connection pair may not be affected even if there is no support from other objects, such a support includes that there is a gap between the tapered thread connection pair and the fastened workpiece. In this way, the weight of the equipment will be greatly reduced, invalid loads will be removed, the technical demands of effective loading capacity, brake performance, energy saving and emission reduction on the equipment will be improved, which are thread technical advantages that are not provided by other thread technologies, but are only provided when the tapered thread connection pair of the connection structure of the bolt and the nut of the bidirectional tapered thread is in a relationship of a non-rigid connection or a rigid connection with the fastened workpiece.

When the connection structure of the bolt and the nut of the bidirectional tapered thread is in transmission connection, bidirectional load bearing is achieved by the screw connection of the bidirectional tapered hole and the bidirectional truncated cone body. There must be a clearance between the bidirectional truncated cone body and the bidirectional tapered body. If there is oil and other mediums for lubrication between the internal thread and the external thread, it will easily form a load bearing oil film. The clearance is conducive to the formation of the load bearing oil film. The connection structure of the bolt and the nut of the bidirectional tapered thread is applied in transmission connection, which is equivalent to a group of sliding bearing pairs composed of one pair and/or several pairs of sliding bearings, that is, each pitch of the traditional internal thread bidirectionally houses the corresponding pitch of the bidirectional tapered external thread to form a pair of sliding bearings, the number of the sliding bearings formed is adjusted according to the application conditions, that is, the number of the pitches of the housing screw threads and the housed screw threads for the effective bidirectional joint, that is, the effective bidirectional contact cohesion of the traditional internal thread and the bidirectional tapered external thread is designed according to the application conditions. Through housing of the bidirectional tapered hole for the bidirectional truncated cone body and positioning in multiple directions such as radial, axial, angular, and circumferential directions, preferably, through housing of the bidirectional tapered hole for the bidirectional truncated cone body and positioning of the internal cone and the external cone in multiple directions, which is formed by main positioning in radial and circumferential directions and auxiliary positioning in axial and angular directions until the bidirectional tapered hole conical surface and the bidirectional truncated cone body conical surface are cohered to achieve the self-positioning or until the sizing interference contact to achieve the self-locking, a special composition technology of the cone pair and the thread pair is constituted, so as to ensure the transmission connection accuracy, efficiency and reliability of the tapered thread technology, especially the connection structure of the bolt and the nut of the bidirectional tapered thread.

When the connection structure of the bolt and the nut of the bidirectional tapered thread is in fastened and sealed connections, its technical performances are achieved by the screw connection of the bidirectional tapered hole and the bidirectional truncated cone body, that is, the first helical conical surface of the truncated cone body and the first helical conical surface of the tapered hole are sized until the interference and/or the second helical conical surface of the truncated cone body and the second helical conical surface of the tapered hole are sized until the interference. Load bearing in one direction and/or in two directions simultaneously are/is achieved according to the application conditions, that is, the bidirectional truncated cone body and the special tapered hole achieve that internal and external diameters of the internal cone and the external cone are centralized under the guidance of the helical line until the first helical conical surface of the tapered hole and the first helical conical surface of the truncated cone body are cohered to achieve load bearing in one direction or simultaneously load bearing in two directions for the sizing fit until the sizing interference contact and/or the second helical conical surface of the tapered hole and the second helical conical surface of the truncated cone body are cohered until load bearing in directions or simultaneously load bearing in two directions for the sizing fit or until the sizing interference contact, that is, through housing of the bidirectional internal cone of the tapered internal thread for the tapered external thread of the tapered external thread for self-locking and positioning in multiple directions such as radial, axial, angular, and circumferential directions, preferably, through housing of the bidirectional tapered hole for the bidirectional truncated cone body and positioning of the internal cone and the external cone in multiple directions, which is formed by main positioning in radial and circumferential directions and auxiliary positioning in axial and angular directions until the bidirectional tapered hole conical surface and the bidirectional truncated cone body conical surface are cohered to achieve the self-positioning or until the sizing interference contact to achieve the self-locking, a special composition technology of the cone pair and the thread pair is constituted, so as to ensure the efficiency and the reliability of the tapered thread technology, especially the connection structure of the bolt and the nut of the bidirectional tapered thread, thereby realizing the technical performances such as connecting performance, locking capability, anti-loosening property, load bearing capability, fatigue resistance and sealing property of a mechanical structure.

Accordingly, the technical performances such as transmission accuracy and efficiency, load bearing capability, self-locking force, anti-loosening capability and sealing property of the connection structure of the bolt and the nut of the bidirectional tapered thread are related to the first helical conical surface of the truncated cone body and the left taper (that is, the first taper angle α1) formed therefrom and the second helical conical surface of the truncated cone body and the right taper (that is, the second taper angle α2) formed therefrom as well as the first helical conical surface of the tapered hole and the left taper (that is, the first taper angle α1) formed therefrom and the second helical conical surface of the tapered hole and the right taper (that is, the second taper angle α2) formed therefrom. The friction coefficient, the processing quality and the application conditions of a material of which the columnar body and the cylindrical body are made have a certain influence on the cone fit.

In the above-mentioned connection structure of the bolt and the nut of the bidirectional tapered thread, when the right-angled trapezoid union makes one revolution at a constant speed, a distance that the right-angled trapezoid union axially moves is equal to at least one times the sum of the lengths of right-angled sides of the two right-angled trapezoids with the same lower bottom sides and the same upper bottom sides but different right-angled sides. This structure ensures that the first helical conical surface of the truncated cone body and the second helical conical surface of the truncated cone body as well as the first helical conical surface of the tapered hole and the second helical conical surface of the tapered hole are enough in length, thereby ensuring enough effective contact area and strength when the bidirectional truncated cone body conical surface matches with the bidirectional tapered hole conical surface, as well as the efficiency required for the helical movement.

In the above-mentioned connection structure of the bolt and the nut of the bidirectional tapered thread, when the right-angled trapezoid union makes one revolution at a constant speed, a distance that the right-angled trapezoid union axially moves is equal to the sum of the lengths of right-angled sides of the two right-angled trapezoids with the same lower bottom sides and the same upper bottom sides but different right-angled sides. This structure ensures that the first helical conical surface of the truncated cone body and the second helical conical surface of the truncated cone body as well as the first helical conical surface of the tapered hole and the second helical conical surface of the tapered hole are enough in length, thereby ensuring enough effective contact area and strength when the bidirectional truncated cone body conical surface matches with the bidirectional tapered hole conical surface, as well as the efficiency required for the helical movement.

In the above-mentioned connection structure of the bolt and the nut of the bidirectional tapered thread, the first helical conical surface of the truncated cone body and the second helical conical surface of the truncated cone body are both continuous helical surfaces or non-continuous helical surfaces. The first helical conical surface of the tapered hole and the second helical conical surface of the tapered hole are both continuous helical surfaces or non-continuous helical surfaces.

In the above-mentioned connection structure of the bolt and the nut of the bidirectional tapered thread, when the connecting hole of the cylindrical body is screwed into a screwing end of the columnar body, there is a requirement for a screwing direction, that is, it is impossible for the connecting hole the cylindrical body to be reversely screwed into the screwing end of the columnar body.

In the above-mentioned connection structure of the bolt and the nut of the bidirectional tapered thread, a head a size of which is greater than the external diameter of the columnar body is disposed at one end of the columnar body and/or one head and/or two heads a size of which is less than a minor diameter of the bidirectional tapered external thread of the screw body of the columnar body are/is disposed at one end and/or two ends of the columnar body, and the connecting hole is a threaded hole provided in a nut. That is, the columnar body and the head are connected as a bolt here, a stud has no head and/or has heads a size of which is less than the minor diameter of the bidirectional tapered external thread at two ends and/or has no screw thread in the middle and has two bidirectional tapered external threads respectively at two ends, and the connecting hole is disposed within the nut.

Compared with the prior art, the connection structure of the bolt and the nut of the bidirectional tapered thread has the following advantages of reasonable design, simple structure, convenient operation, large locking force, large load bearing capability, good anti-loosening property, high transmission efficiency and accuracy, good mechanical sealing effect and good stability, may prevent the loosening from occurring during the connection, has self-locking and self-positioning functions, and achieves fastening and connecting functions by bidirectional load bearing or sizing of the cone pair that is formed by coaxial centralizing of the internal diameter and the external diameter of the internal cone and the external cone until the sizing interference fit.

### DESCRIPTION OF THE DRAWINGS

FIG. 1 is a schematic diagram showing a connection structure of a bolt and double nuts of an asymmetric bidirectional tapered thread in an olive-like shape (in which a left taper is greater than a right taper) according to a first embodiment of the present invention.

FIG. 2 is a schematic diagram showing a structure of a bolt of an external thread of an asymmetric bidirectional tapered thread in an olive-like shape (in which a left taper is greater than a right taper) and a complete unit thread thereof according to a first embodiment of the present invention.

FIG. 3 is a schematic diagram showing a structure of a nut body of an internal thread of an asymmetric bidirectional tapered thread in an olive-like shape (in which a left taper is greater than a right taper) and a complete unit thread thereof according to a first embodiment of the present invention.

FIG. 4 is a schematic diagram showing a connection structure of a bolt and double nuts of an asymmetric bidirectional tapered thread in an olive-like shape (in which a left taper is greater than a right taper) according to a second embodiment of the present invention.

FIG. 5 is a schematic diagram showing a connection structure of a bolt and a single nut of an asymmetric bidirectional tapered thread in an olive-like shape (in which a left taper is greater than a right taper) according to a third embodiment of the present invention.

FIG. 6 is a schematic diagram showing a connection structure of a bolt and double nuts (a gasket is provided therebetween) of an asymmetric bidirectional tapered thread in an olive-like shape (in which a left taper is greater than a right taper) according to a third embodiment of the present invention.

FIG. 7 is a schematic diagram showing a connection structure of a bolt and double nuts of an asymmetric bidirectional tapered thread in an olive-like shape (in which a left taper is less than a right taper) according to a fourth embodiment of the present invention.

FIG. 8 is a schematic diagram showing a structure of a bolt of an external thread of an asymmetric bidirectional tapered thread in an olive-like shape (in which a left taper is less than a right taper) and a complete unit thread thereof according to a fourth embodiment of the present invention.

FIG. 9 is a schematic diagram showing a structure of a nut body of an internal thread of an asymmetric bidirectional tapered thread in an olive-like shape (in which a left taper is less than a right taper) and a complete unit thread thereof according to a fourth embodiment of the present invention.

FIG. 10 is a schematic diagram showing a connection structure of a hybrid combination of bolts of asymmetric bidirectional tapered external threads in two olive-like shapes including an asymmetric bidirectional tapered thread in an olive-like shape (in which a left taper is less than a right taper) and an asymmetric bidirectional tapered thread in an olive-like shape (in which a left taper is greater than a right taper) and double nuts of an asymmetric bidirectional tapered thread in an olive-like shape according to a fifth embodiment of the present invention.

FIG. 11 is a schematic diagram showing a structure of bolts of asymmetric bidirectional tapered external threads in two olive-like shapes including two taper structure forms of an olive-like shape (in which a left taper is less than a right taper) and an olive-like shape (in which a left taper is greater than a right taper) and a complete unit thread according to a fifth embodiment of the present invention.

FIG. 12 is a schematic diagram showing a structure of a nut body of an internal thread of an asymmetric bidirectional tapered thread in an olive-like shape (in which a left taper is greater than a right taper) and a complete unit thread thereof according to a fifth embodiment of the present invention.

FIG. 13 is a schematic diagram showing a structure of a nut body of an internal thread of an asymmetric bidirectional tapered thread in an olive-like shape (in which a left taper is less than a right taper) and a complete unit thread thereof according to a fifth embodiment of the present invention.

FIG. 14 is an illustration that “a screw thread in the existing screw thread technology is an inclined surface on a cylindrical surface or a conical surface” involved in the background art of the present invention.

FIG. 15 is an illustration of “an inclined surface slider model adopting a principle of the existing screw thread technology, that is, an inclined surface principle” involved in the background art of the present invention.

FIG. 16 is an illustration of “a thread lift angle in the existing screw thread technology” involved in the background art of the present invention.

In the figures, 1—tapered thread; 2—cylindrical body; 21—nut body, 22—nut body; 3—columnar body; 31—screw body, 20—polish rod; 4—tapered hole; 41—bidirectional tapered hole; 42—bidirectional tapered hole conical surface; 421—first helical conical surface of tapered hole; α1—first taper angle; 422—second helical conical surface of tapered hole; α2—second taper angle; 5—internal helical line; 6—internal thread; 7—special tapered body; 71: bidirectional truncated cone body; 72—bidirectional truncated cone body conical surface; 721—first helical conical surface of truncated cone body; α1—first taper angle; 722: second helical conical surface of truncated cone body; α2—second taper angle; 8—external helical line; 9—external thread; 93—olive-like shape; 95—left taper, 96—right taper; 97—leftward distribution; 98—rightward distribution; 10—connection pair for thread and/or thread pair; 101—clearance; 111—locking bearing surface; 112—locking bearing surface; 122—bearing surface of tapered thread; 121—bearing surface of tapered thread; 130—workpiece; 01—cone axis; 02—thread axis; A—slider on inclined surface body; B—inclined surface body; G—gravity; G1—gravity component along inclined surface; F—friction force; φ—thread lift angle; P—equivalent friction angle; d—major diameter of traditional external thread; d1—minor diameter of traditional external thread; and d2—pitch diameter of traditional external thread.

### DETAILED DESCRIPTION OF PREFERRED EMBODIMENTS

The present invention will be further described in detail below in conjunction with accompanying drawings and the specific embodiments.

### A First Embodiment

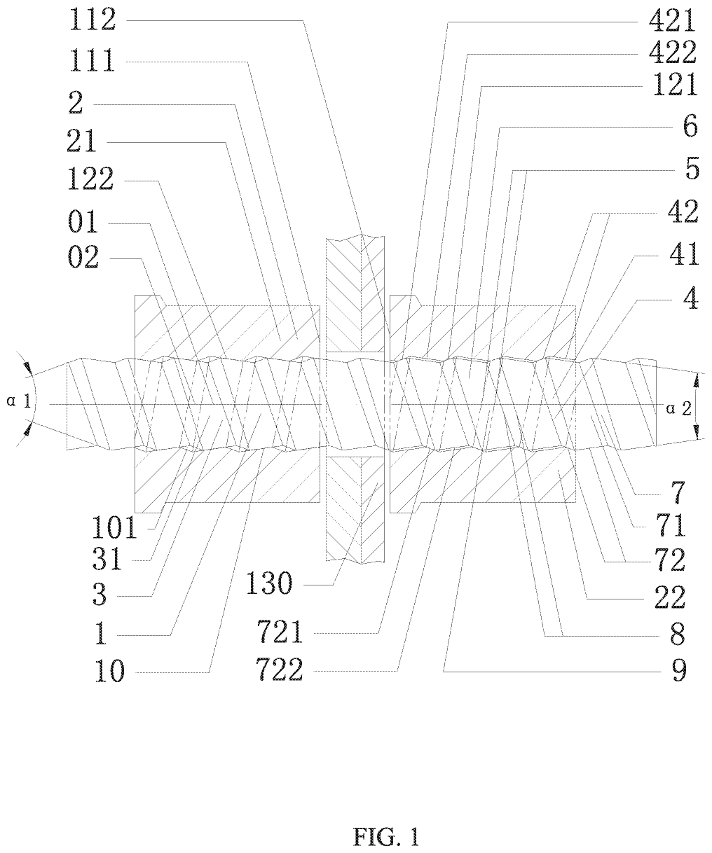

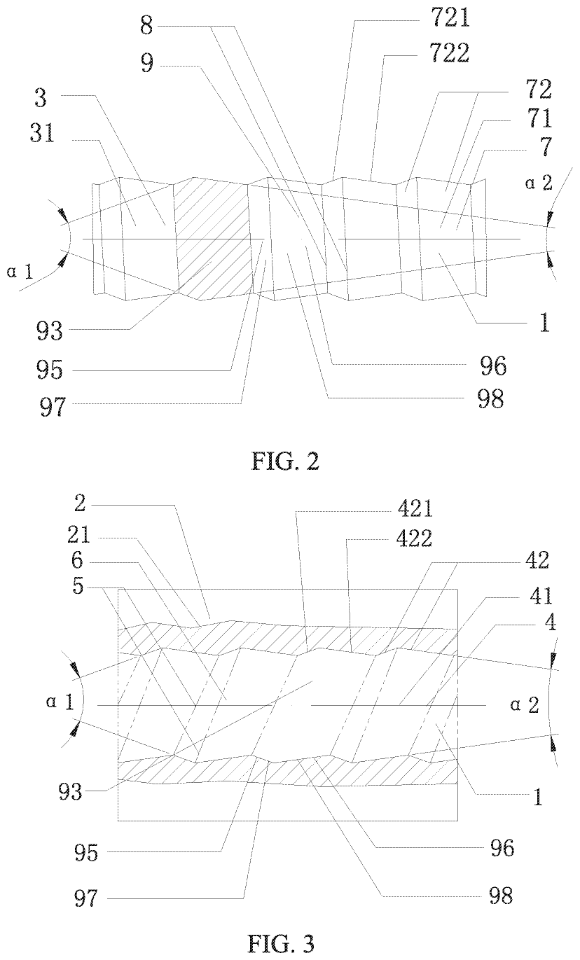

As shown in FIG. 1, FIG. 2 and FIG. 3, the present embodiment provides a connection structure of a bolt and two nuts, including a bidirectional truncated cone body 71 helically distributed on the external surface of the columnar body 3 and a bidirectional tapered hole 41 helically distributed on the internal surface of the cylindrical body 2, that is, an external thread 9 and an internal thread 5 in mutual thread fit, the internal thread 6 is provided with the bidirectional helical tapered hole 41 and exists in the form of a “non-entity space”, and the external thread is provided with the bidirectional helical truncated cone body 71 and exists in the form of a “material entity”. The internal thread 6 and the external thread 9 are in a relationship of a housing member and a housed member. The threads work in such a state that the internal thread 6 and the external thread 9 are fitted together by screwing the two bidirectional tapered geometries pitch by pitch, and the internal thread is cohered with the external thread till the external thread and the internal thread are in interference fit, that is, the bidirectional tapered hole 41 houses the bidirectional truncated cone body 71 pitch by pitch. Bidirectional housing limits a disordered degree of freedom between the tapered hole 4 and the truncated cone body 7, and the helical movement allows the tapered thread connection pair 10 of the bolt and the nuts of the bidirectional tapered thread the to obtain a necessary ordered degree of freedom. Accordingly, technical characteristics of a cone pair and a thread pair are effectively composed.

According to the connection structure of the bolt and the nuts of the bidirectional tapered thread in the present embodiment, the tapered thread connection pair 10 has self-locking and self-positioning properties as long as the truncated cone body 7 and/or the tapered hole 4 of the tapered thread connection pair 10 reach/reaches a certain taper, that is, the cone constituting the cone pair reaches a certain taper angle. The tapers include a left taper 95 and a right taper 96, and the taper angles include a left taper angle and a right taper angle. In the asymmetric bidirectional tapered thread 1 of the present embodiment, the left taper 95 is greater than the right tapers 96. The left taper 95 corresponds to the left taper angle, that is, the first taper angle α1, preferably, the first taper angle α1 is greater than 0° and less than 53°, preferably, the first taper angle α1 takes a value in a range from 2° to 40°. For individual special fields, that is, connection application fields without self-locking property and/or with poor self-positioning property and/or with high axial load bearing capacity requirement, preferably, the first taper angle α1 is greater than or equal to 53° and less than 180°, and preferably, the first taper angle α1 takes a value in a range from 53° to 90°; and the right taper 96 corresponds to the right taper angle, that is, the second taper angle α2, preferably, the second taper angle α2 is greater than 0° and less than 53°, and the second taper angle α2 takes a value in a range from 2° to 40°.

The external thread 9 is arranged on the external surface of the columnar body 3, wherein a screw body 31 is disposed on the columnar body 3, a helically distributed truncated cone body 7 including an symmetric bidirectional truncated cone body 71 is disposed on the external surface of the screw body 31, the asymmetric bidirectional truncated cone body 71 is a special bidirectional conical geometry in an olive-like shape 93, and the columnar body 3 may be solid or hollow, including workpieces and objects such as cylinders, cones, pipes and the like that need to be machined with external threads on their external surfaces.

The asymmetric bidirectional truncated cone body 71 in an olive-like shape 93 is characterized by being formed by symmetrically and oppositely joining lower bottom surfaces of the two truncated cone bodies with the same lower bottom surfaces and the same upper top surfaces but different heights, and upper top surfaces are disposed on two ends of the bidirectional truncated cone bodies 71 to form the asymmetric bidirectional tapered thread 1, and the process includes that the upper top surfaces are respectively fitted with upper top surfaces of adjacent bidirectional truncated cone bodies 71 and/or respectively fitted with upper top surfaces of adjacent bidirectional truncated cone bodies 71. The asymmetric bidirectional truncated cone body conical surface 72 is disposed on the external surface of the truncated cone body 7. The external thread 9 includes a first helical conical surface 721 of the truncated cone body, a second helical conical surface 722 of the truncated cone body, and an external helical line 8. Within a cross section passing through the thread axis 02, the complete single-pitch asymmetric bidirectional tapered external thread 9 is a special bidirectional tapered geometry in an olive-like shape 93, with a large middle and two small ends, and with the taper of the left truncated cone body greater than that of the right truncated cone body. The asymmetric bidirectional truncated cone body 71 includes a bidirectional conical surface 72 of the truncated cone body, wherein an included angle between two plain lines of a left conical surface (that is, the first helical conical surface 721 of the truncated cone body) of the asymmetric bidirectional truncated cone body 71 is a first taper angle α1, and the first helical conical surface 721 of the truncated cone body forms the left taper 95 and is in a leftward distribution 97; and an included angle α2 between two plain lines of a right conical surface (that is, the second helical conical surface 722 of the truncated cone body) of the asymmetric bidirectional truncated cone body 71 is a second taper angle α2, and the second helical conical surface 722 of the truncated cone body forms the right taper and is in a rightward distribution 98. Taper directions corresponding to the first taper angle α1 and the second taper angle α2 are opposite, and the plain lines are intersecting lines of the conical surface with the plane passing through the cone axis 01. A shape formed by the first helical conical surface 721 of the truncated cone body and the second helical conical surface 722 of the truncated cone body of the bidirectional truncated cone body 71 is the same as a shape of an external helical lateral surface of a rotary body, wherein the rotary body is formed by two inclined sides of a right-angled trapezoid union when the right-angled trapezoid union axially moves at a constant speed along a central axis of the columnar body 3 while circumferentially rotating at a constant speed with right-angled sides of the right-angled trapezoid union as a rotation center, wherein the right-angled trapezoid union is formed by symmetrically and oppositely joining lower bottom sides of two right-angled trapezoids with the same lower bottom sides and the same upper bottom sides but different right-angled sides, wherein the right-angled trapezoids coincide with the central axis of the columnar body 3. The right-angled trapezoid union refers to a special geometry in which the lower bottom sides of the two right-angled trapezoids with the same lower bottom sides and the same upper bottom sides but different right-angled sides are symmetrically and oppositely joined and the upper bottom sides thereof are respectively located at two ends of the right-angled trapezoid union.

The internal thread 6 is arranged on the internal surface of the cylindrical body 2, wherein the cylindrical body 2 includes a nut body 21 and a nut body 22, wherein a helically distributed tapered hole 4 including an asymmetric bidirectional tapered hole 41 is provided in the nut body 21, the asymmetric bidirectional tapered hole 41 is a special bidirectional conical geometry in an olive-like shape 93, and the cylindrical body 2 includes cylindrical workpieces and objects and/or non-cylindrical workpieces and objects that need to be machined with internal threads on their internal surfaces.

The asymmetric bidirectional tapered hole 41 in an olive-like shape 93 is characterized by being formed by symmetrically and oppositely joining lower bottom surfaces of the two tapered holes with the same lower bottom surfaces and the same upper top surfaces but different heights, and upper top surfaces are disposed on two ends of the bidirectional tapered hole 41 to form the bidirectional tapered thread 1, and the process includes that the upper top surfaces are respectively fitted with upper top surfaces of adjacent bidirectional tapered holes 41 and/or respectively fitted with upper top surfaces of adjacent bidirectional tapered holes 41. The internal thread 6 includes a first helical conical surface 421 of the tapered hole, a second helical conical surface 421 of the tapered hole, and an internal helical line 5. Within a cross section passing through the thread axis, the complete single-pitch symmetric bidirectional tapered internal thread 6 is a special bidirectional tapered geometry in an olive-like shape 93, with a large middle and two small ends, and with the taper of the left tapered hole greater than that of the right tapered hole. The bidirectional tapered hole 41 includes a bidirectional tapered hole conical surface 42, wherein an included angle between two plain lines of a left conical surface (that is, the first helical conical surface 421 of the tapered hole) of the bidirectional tapered hole 41 is a first taper angle α1, and the first helical conical surface 421 of the tapered hole forms the left taper 95 and is in a leftward distribution 97; and an included angle α2 between two plain lines of a right conical surface (that is, the second helical conical surface 422 of the tapered hole) of the bidirectional tapered hole 41 is a second taper angle α2, and the second helical conical surface 422 of the tapered hole forms the right taper 96 and is in a rightward distribution 98. Taper directions corresponding to the first taper angle α1 and the second taper angle α2 are opposite, and the plain lines are intersecting lines of the conical surface with the plane passing through the cone axis. A shape formed by the first helical conical surface 421 of the tapered hole and the second helical conical surface 422 of the tapered hole of the bidirectional tapered hole 41 is the same as a shape of an external helical lateral surface of a rotary body, wherein the rotary body is formed by two inclined sides of a right-angled trapezoid union when the right-angled trapezoid union axially moves at a constant speed along a central axis of the cylindrical body 2 while circumferentially rotating at a constant speed with right-angled sides of the right-angled trapezoid union as a rotation center, wherein the right-angled trapezoid union is formed by symmetrically and oppositely joining lower bottom sides of two right-angled trapezoids with the same lower bottom sides and the same upper bottom sides but different right-angled sides, wherein the right-angled trapezoids coincide with the central axis of the cylindrical body 2. The right-angled trapezoid union refers to a special geometry in which the lower bottom sides of the two right-angled trapezoids with the same lower bottom sides and the same upper bottom sides but different right-angled sides are symmetrically and oppositely joined and the upper bottom sides thereof are respectively located at two ends of the right-angled trapezoid union.

The connection structure of the bolt and the double nuts is adopted in the present embodiment. The double nuts include a nut body 21 and a nut body 22, wherein the nut body 21 is located at the left side of a fastened workpiece 130, and the nut body 22 is located at the right side of the fastened workpiece 130. During operation, the connection structure of the bolt and the double nuts is in a relationship of a rigid connection with the fastened workpiece 130. The rigid connection means that a bearing surface on the end surface of each nut and a bearing surface of the workpiece 130 serve as bearing surfaces each other, and the bearing surfaces include a locking bearing surface 111 and a locking bearing surface 112. The workpiece 130 refers to a connected object including the workpiece 130.

Thread working bearing surfaces in the present embodiment are different and include a bearing surface 121 of the tapered thread and a bearing surface 122 of the tapered thread. When a cylindrical body 2 is located at the left side of the fastened workpiece 130, that is, the left end surface of the fastened workpiece 130 and the right end surface of the cylindrical body 2, that is, the left nut body 21, are the locking bearing surfaces 111 of the left nut body 21 and the fastened workpiece 130, right helical conical surfaces of bidirectional tapered threads 1 of the left nut body 21 and the columnar body 3, that is, the screw body 31, that is, the bolt, are thread working bearing surfaces, that is, the second helical conical surface 422 of the tapered hole and the second helical conical surface 722 of the truncated cone body are bearing surfaces 122 of the tapered thread, and the second helical conical surface 422 of the tapered hole and the second helical conical surface 722 of the truncated cone body serve as bearing surfaces each other. When the cylindrical body 2 is located at the right side of the fastened workpiece 130, that is, the right end surface of the fastened workpiece 130 and the left end surface of the cylindrical body 2, that is, a right nut body 22 are the locking bearing surfaces 112 of the right nut body 22 and the fastened workpiece 130, left helical conical surfaces of the bidirectional tapered threads 1 of the right nut body 22 and the columnar body, that is, the screw body 31, that is, the bolt, are tapered working bearing surfaces, that is, the first helical conical surface 421 of the tapered hole and the first helical conical surface 721 of the truncated cone body are bearing surfaces 121 of the tapered thread, and the first helical conical surface 421 of the tapered hole and the first helical conical surface 721 of the truncated cone body serve as bearing surfaces each other.

When the connection structure of the bolt and the nuts of the bidirectional tapered thread is in transmission connection, bidirectional load bearing is achieved by the screw connection of the bidirectional tapered hole 41 and the bidirectional truncated cone body 71. There must be a clearance 101 between the bidirectional tapered hole 41 and the bidirectional truncated cone body 71. The clearance 101 is conducive to the formation of a load bearing oil film. The tapered thread connection pair 10 is equivalent to a group of sliding bearing pairs composed of one pair and/or several pairs of sliding bearings, that is, each pitch of the bidirectional tapered internal thread 6 bidirectionally houses the corresponding pitch of the bidirectional tapered external thread 9 to form a pair of sliding bearings, the number of the sliding bearings formed is adjusted according to the application conditions, that is, the number of the pitches of the housing screw threads and the housed screw threads for the effective bidirectional joint, that is, the effective bidirectional contact cohesion, of the bidirectional tapered internal thread 6 and the bidirectional tapered external thread 9 is designed according to the application conditions. Through bidirectional housing of the tapered hole 4 for the bidirectional truncated cone body 7 and positioning in multiple directions such as radial, axial, angular, and circumferential directions, the transmission connecting accuracy, efficiency and reliability of the bidirectional tapered thread are ensured.

When the connection structure of the bolt and the nuts of the bidirectional tapered thread in the present embodiment is in fastened and sealed connections, technical performances are achieved by the screw connection of the bidirectional tapered hole 41 and the bidirectional truncated cone body 71, that is, the first helical conical surface 721 of the truncated cone body and the first helical conical surface 421 of the tapered hole are sized until the interference and/or the second helical conical surface 722 of the truncated cone body and the second helical conical surface 422 of the tapered hole are sized until the interference. Load bearing in one direction and/or in two directions simultaneously are/is achieved according to the application conditions, that is, the bidirectional truncated cone body 71 and the bidirectional tapered hole 41 achieve that internal and external diameters of the internal cone and the external cone are centralized under the guidance of the helical line until the first helical conical surface 421 of the tapered hole and the first helical conical surface 721 of the truncated cone body are cohered until the interference contact and/or the second helical conical surface 422 of the tapered hole and the second helical conical surface 722 of the truncated cone body are cohered until the interference contact, thereby achieving technical performances such as connecting performance, locking capability, anti-loosening property, load bearing capability, fatigue resistance and sealing property of a mechanical structure.

Accordingly, the technical performances such as transmission accuracy and efficiency, load bearing capability, self-locking force, anti-loosening capability, sealing performance and reusability of the connection structure of the bolt and the nuts of the bidirectional tapered thread are related to the first helical conical surface 721 of the truncated cone body and the left taper 95 (that is, the first taper angle α1) formed therefrom and the second helical conical surface 722 of the truncated cone body and the right taper 96 (that is, the second taper angle α2) formed therefrom as well as the first helical conical surface 421 of the tapered hole and the left taper formed 95 (that is, the first taper angle α1) formed therefrom and the second helical conical surface 422 of the tapered hole and the right taper 96 (that is, the second taper angle α2) formed therefrom. The friction coefficient, the processing quality and the application conditions of a material of which the columnar body 3 and the cylindrical body 2 are made have a certain influence on the cone fit.

In the above-mentioned connection structure of the bolt and the nuts of the bidirectional tapered thread, when the right-angled trapezoid union makes one revolution at a constant speed, a distance that the right-angled trapezoid union axially moves is equal to at least one times the sum of the lengths of right-angled sides of the two right-angled trapezoids with the same lower bottom sides and the same upper bottom sides but different right-angled sides. This structure ensures that the first helical conical surface 721 of the truncated cone body and the second helical conical surface 722 of the truncated cone body as well as the first helical conical surface 421 of the tapered hole and the second helical conical surface 422 of the tapered hole are enough in length, thereby ensuring enough effective contact area and strength when the bidirectional conical surface 72 of the truncated cone body matches with the bidirectional conical surface 42 of the tapered hole, as well as the efficiency required for the helical movement.

In the above-mentioned connection structure of the bolt and the nuts of the bidirectional tapered thread, when the right-angled trapezoid union makes one revolution at a constant speed, a distance that the right-angled trapezoid union axially moves is equal to the sum of lengths of right-angled sides of the two right-angled trapezoids with the same lower bottom sides and the same upper bottom sides but different right-angled sides. This structure ensures that the first helical conical surface 721 of the truncated cone body and the second helical conical surface 722 of the truncated cone body as well as the first helical conical surface 421 of the tapered hole and the second helical conical surface 422 of the tapered hole are enough in length, thereby ensuring enough effective contact area and strength when the bidirectional conical surface 72 of the truncated cone body matches with the bidirectional conical surface 42 of the tapered hole, as well as the efficiency required for the helical movement.

In the above-mentioned connection structure of the bolt and the nuts of the bidirectional tapered thread, the first helical conical surface 721 of the truncated cone body and the second helical conical surface 722 of the truncated cone body are both continuous helical surfaces or non-continuous helical surfaces. The first helical conical surface 421 of the tapered hole and the second helical conical surface 422 of the tapered hole are both continuous helical surfaces or non-continuous helical surfaces.

In the above-mentioned connection structure of the bolt and the nuts of the bidirectional tapered thread, a connecting hole of the cylindrical body 2 is screwed into a screwing end of the columnar body 3, there is a requirement for a screwing direction of the connecting hole, and the connecting hole is not allowed to be reversely screwed into the screwing end of the columnar body 3.

In the above-mentioned connection structure of the bolt and the nuts of the bidirectional tapered thread, when a connecting hole of the cylindrical body 2 is screwed into a screwing end of the columnar body 3, there is a requirement for a screwing direction, and it is impossible for the connecting hole of the cylindrical body to be reversely screwed into the screwing end of the columnar body 3. A head a size of which is greater than the external diameter of the columnar body 3 is disposed at one end of the columnar body 3 and/or one head and/or two heads a size of which is less than a minor diameter of the bidirectional tapered external thread 9 of a screw body 31 of the columnar body 3 are/is disposed at one end and/or two ends of the columnar body 3, and the connecting hole is a threaded hole provided in a nut 1. That is, the columnar body 3 and the head are connected as the bolt here, and a stud has no head and/or has heads a size of which is less than the minor diameter of the bidirectional tapered external thread 9 at two ends and/or has no screw thread in the middle and has a bidirectional tapered external thread 9 respectively at two ends.

Compared with the prior art, the tapered thread connection pair 10 of the connection structure of the bolt and the nuts of the bidirectional tapered thread has the following advantages of reasonable design, simple structure, convenient operation, large locking force, large load bearing capability, good anti-loosening property, high transmission efficiency and accuracy, good mechanical sealing effect and good stability, may prevent the loosening from occurring during the connection, has self-locking and self-positioning functions, and achieves fastening and connecting functions by sizing the diameter of the cone pair formed by the internal cone and the external cone until the interference fit.

### A Second Embodiment

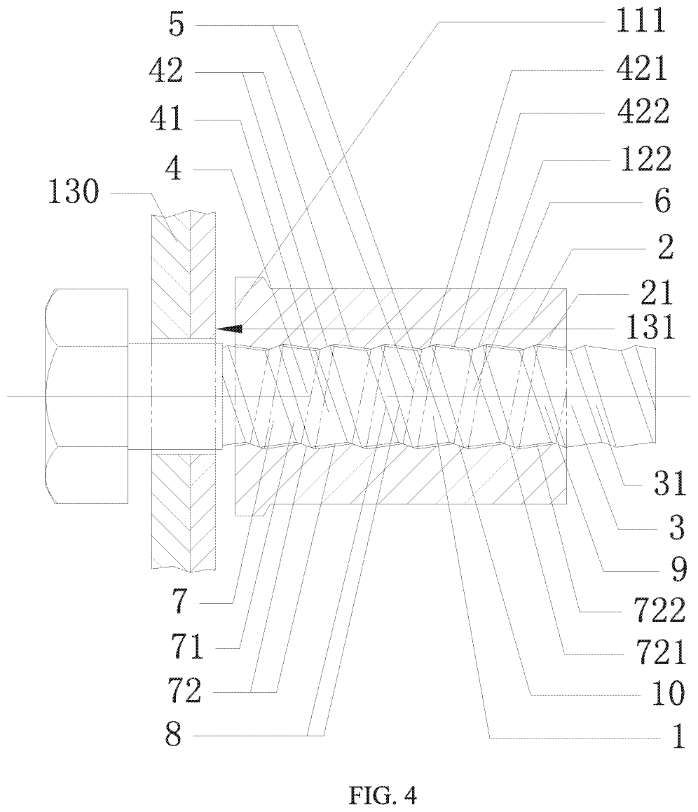

As shown in FIG. 4, the structure, principle and implementation steps of the present embodiment are similar to those of the first embodiment, except that a connection structure of a bolt and a single nut is adopted in the present embodiment, and a bolt body is provided with a hexagonal head larger than the screw body 31. When the hexagonal head of the bolt is located at the left side, the cylindrical body 2, that is, the nut body 21, that is, the single nut, is located at the right side of the fastened workpiece 130. When the connection structure of the bolt and the single nut in the present embodiment operates, the connection structure of the bolt and the single nut are in a relationship of a rigid connection with the fastened workpiece 130. The rigid connection means that end surfaces opposite to an end surface of the nut body 21 and an end surface of the workpiece 130 serve as bearing surfaces each other, and the bearing surface is the locking bearing surface 111. The workpiece 130 refers to a connected object including the workpiece 130.

The thread working bearing surface in the present embodiment is the bearing surface 122 of the tapered thread, that is, the cylindrical body 2, that is, the nut body 21, that is, the single nut, is located at the right side of the fastened workpiece 130. When the connection structure of the bolt and the single nut operates, the right end surface of the workpiece 130 and the left end surface of the nut body 21 are the locking bearing surfaces 111 of the nut body 21 and the fastened workpiece 130, left helical conical surfaces of bidirectional tapered threads 1 of the nut body and the columnar body 3, that is, the screw body 3, that is, the bolt, are thread working bearing surfaces, that is, the first helical conical surface 421 of the tapered hole and the first helical conical surface 721 of the truncated cone body are bearing surfaces 122 of the tapered thread, and the first helical conical surface 421 of the tapered hole and the first helical conical surface 721 of the truncated cone body serve as bearing surfaces each other.

In the present embodiment, the structure, principle and implementation steps of the hexagonal head of the bolt are similar to those of the present embodiment when being located at the right side.

### A Third Embodiment

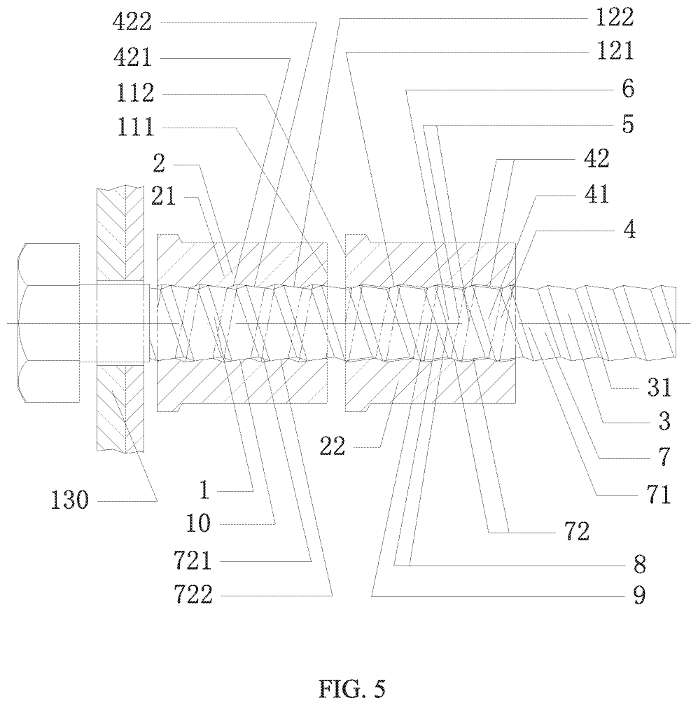

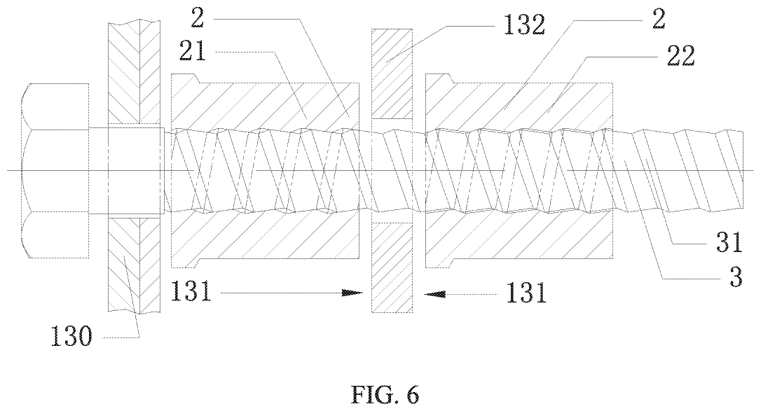

As shown in FIG. 5 and FIG. 6, the structure, principle and implementation steps of the present embodiment are similar to those of the first embodiment, except that there is a different position relationship between each of the double nuts and the fastened workpiece 130, the double nuts include a nut body 21 and a nut body 22, and a bolt body is provided with a hexagonal head larger than the screw body 31. When the hexagonal head of the bolt is located at the left side, the nut body 21 and the nut body 22 are both located at the right side of the fastened workpiece 130. When the connection structure of the bolt and the double nuts operates, the nut body 21, the nut body 22 and the fastened workpiece 130 are in a relationship of a non-rigid connection. The non-rigid connection means that end surfaces at opposite sides of the double nuts, that is, the nut body 21 and the nut body 22, serve as bearing surfaces each other, the bearing surfaces include a locking bearing surface 111 and a locking bearing surface 112. The non-rigid connection is mainly applied to a non-rigid material or a non-rigid connecting workpiece 130 such as a transmission member or application fields in which demands are met by mounting the double nuts. The workpiece 130 refers to a connected object including the workpiece 130.

Tread working bearing surfaces in the present embodiment are different and include a bearing surface 121 of the tapered thread and a bearing surface 122 of the tapered thread. A cylindrical body 2 includes a left nut body 21 and a right nut body 22, and the right end surface, that is, the locking bearing surface 111, of the left nut body 21 and the left end surface, that is, the locking bearing surface 112, of the right nut body 22 are oppositely in direct contact and serve as locking bearing surfaces each other. When the right end surface of the left nut body 21 is the locking bearing surface 111, right helical conical surfaces of bidirectional tapered threads 1 of the left nut 21 and the columnar body 3, that is, the screw body 31, that is, the bolt, are thread working bearing surfaces, that is, the second helical conical surface 422 of the tapered hole and the second helical conical surface 722 of the truncated cone body are the bearing surfaces 122 of the tapered thread, and the second helical conical surface 422 of the tapered hole and the second helical conical surface 722 of the truncated cone body serve as bearing surfaces each other. When the left end surface of the right nut body 22 is the locking bearing surface 112, left helical conical surfaces of the bidirectional tapered threads 1 of the right nut body 22 and the columnar body 3, that is, the screw body 31, that is, the bolt, are thread working bearing surfaces, that is, the first helical conical surface 421 of the tapered hole and the first helical conical surface 721 of the truncated cone body are bearing surfaces 121 of the tapered thread, and the first helical conical surface 421 of the tapered hole and the first helical conical surface 721 of the truncated cone body serve as bearing surfaces each other.

In the present embodiment, when the cylindrical body 2 located at the inner side, that is, the nut body 21 adjacent to the fastened workpiece 130, has been effectively combined with a columnar body 3, that is, the screw body 31, that is, the bolt, i.e., an internal thread 6 and an external thread 9 forming a connection pair 10 for a tapered thread are effectively cohered together. A cylindrical body 2 located at the outer side, that is, the nut body 22 not adjacent to the fastened workpiece 130, may keep unchanged and/or may be removed with one nut being retained according to the application condition (such as application fields in which there are requirements on light weight of equipment or it is unnecessary to guarantee the reliability of a connection technology by double nuts), and the removed nut body 22 is only used as a mounting process nut, rather than a connecting nut. An internal thread of the mounting process nut may be produced from the bidirectional tapered thread and may further adopt the nut body 22 produced from a unidirectional tapered thread and other screw threads including a triangular thread, a trapezoidal thread and a zigzagging thread capable of engaging with the tapered taper 1. On the premise that the reliability of a connection technology is guaranteed, the tapered thread connection pair 10 is a closed-loop fastening technical system, that is, after the internal thread 6 and the external thread 9 of the tapered thread connection pair 10 are effectively cohered together, the tapered thread connection pair 10 will form an independent technical system so as to be capable of guaranteeing the technical effectiveness of a connection technical system without depending on a third-party technology, that is, the effectiveness of the tapered thread connection pair 10 may not be affected even if there is no support from other objects, such a support includes that there is a gap between the tapered thread connection pair 10 and the fastened workpiece 130. In this way, the weight of the equipment will be greatly reduced, invalid loads will be removed, the technical demands of effective loading capacity, brake performance, energy saving and emission reduction on the equipment will be improved, which are thread technical advantages that are not provided by other thread technologies, but are only provided when the tapered thread connection pair 10 of the connection structure of the bolt and the nut of the bidirectional tapered thread is in a relationship of a non-rigid connection or rigid connection with the fastened workpiece 130.

In the present embodiment, when a gasket is provided between the nut body 21 and the nut body 22, the structure, principle and implementation steps thereof are similar to those of the present embodiment.

In the present embodiment, when the hexagonal head of the bolt is located at the right side, the nut body 21 and the nut body 22 are both located at the left side of the fastened workpiece 130, and the structure, principle and implementation steps of the hexagonal head of the bolt are similar to those of the present embodiment.

### A Fourth Embodiment

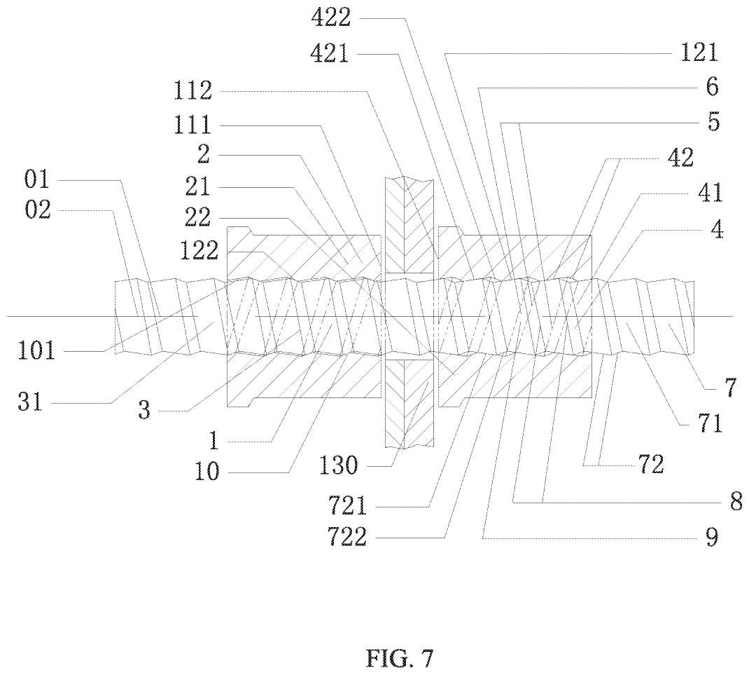

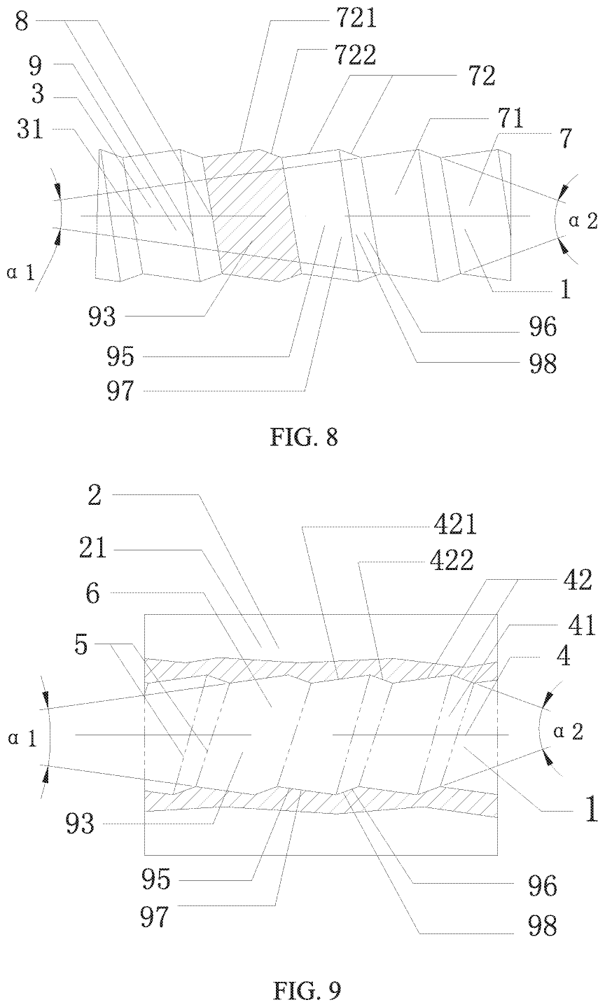

As shown in FIG. 7, FIG. 8 and FIG. 9, the structure, principle and implementation steps of the present embodiment are similar to those of the first embodiment, the second embodiment and the third embodiment, except that, the asymmetric bidirectional tapered thread 1 in the present embodiment has a left taper 95 less than a right taper 96, preferably, a first taper angle α1 is greater than 0° and less than 53°, preferably, the first taper angle α1 takes a value in a range from 2° to 40°; and preferably, a second taper angle α2 is greater than 0° and less than 53°, preferably, the second taper angle α2 takes a value in a range from 2° to 40°. For individual special fields, preferably, the second taper angle α2 is greater than or equal to 53° and less than 180°, preferably, the second taper angle α2 takes a value in a range from 53° to 90°.

### A Fifth Embodiment

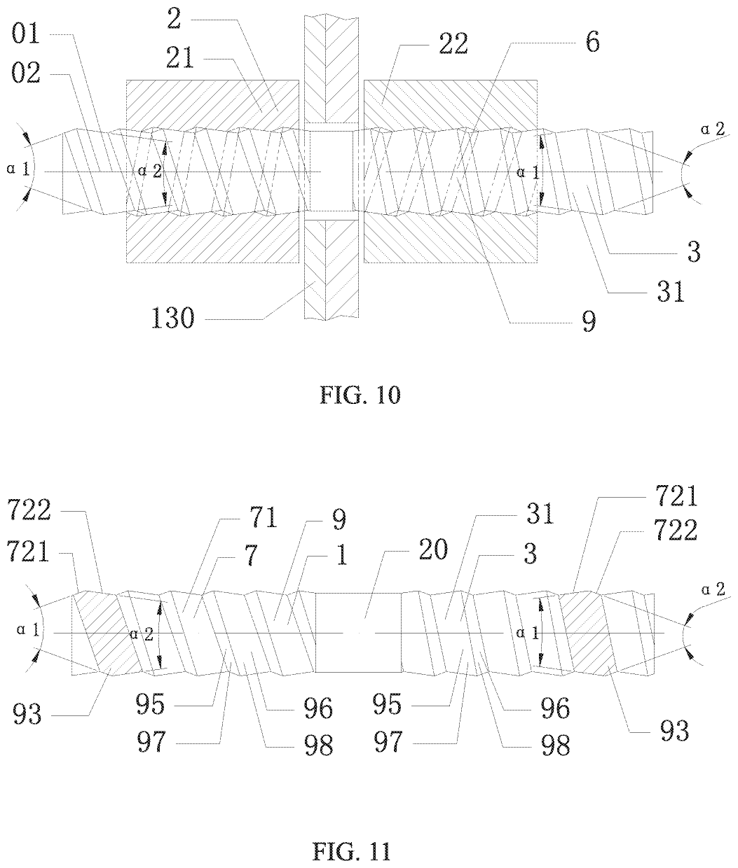

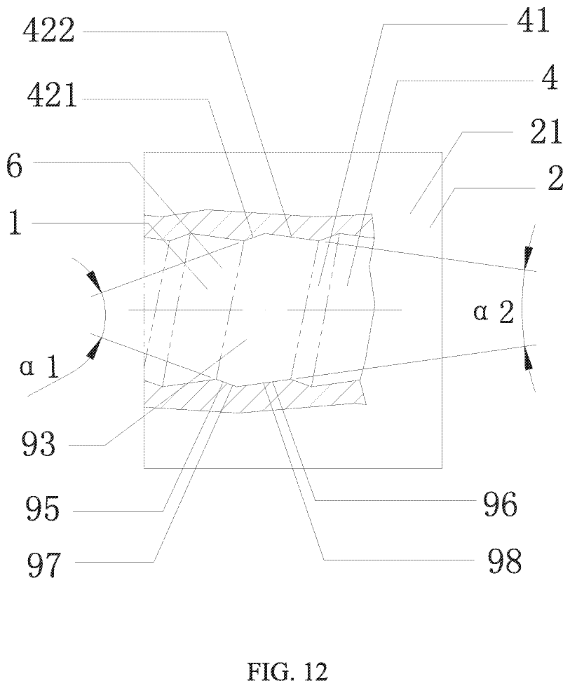

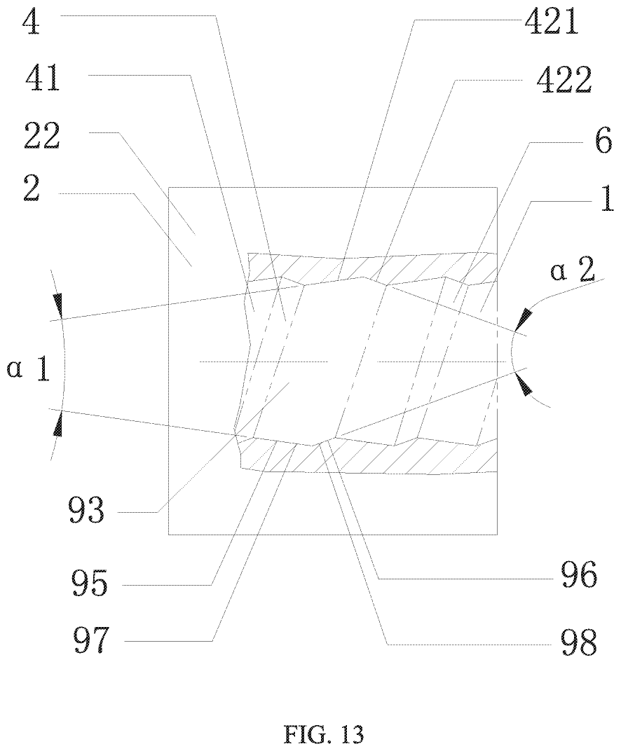

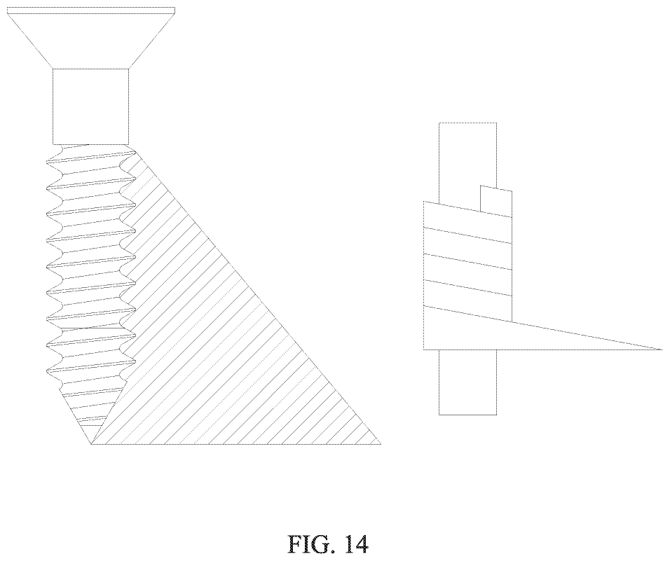

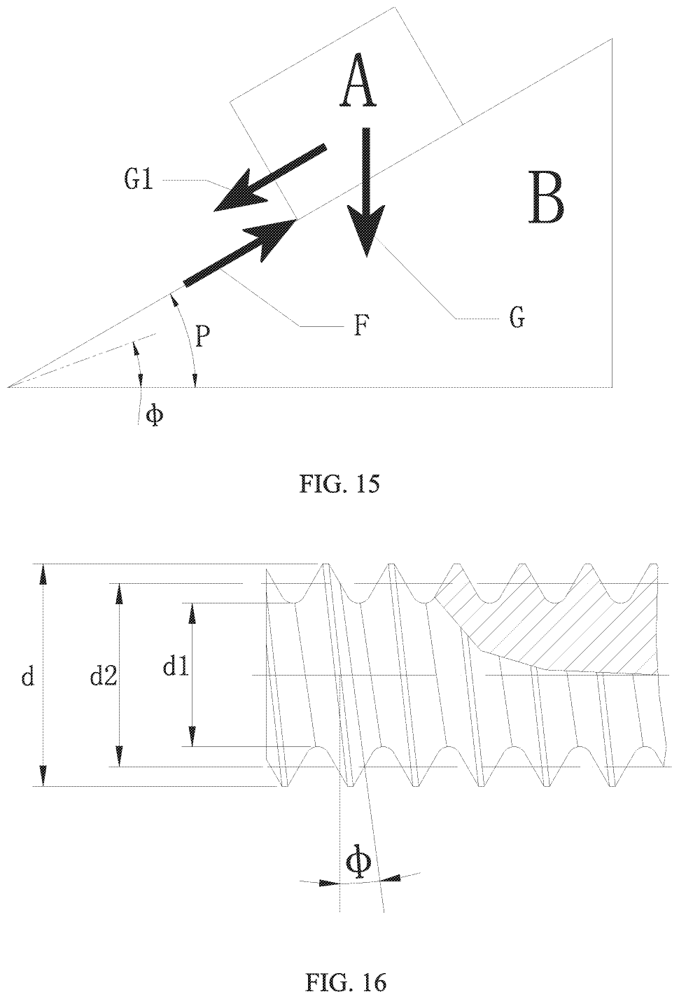

As shown in FIG. 10, FIG. 11, FIG. 12 and FIG. 13, the structure, principle and implementation steps of the present embodiment are similar to the first embodiment and the fourth embodiment, except that the screw body 31 on the cylindrical body 3 in the present embodiment includes screw thread structures of asymmetrical bidirectional tapered threads 1 in two olive-like shapes 93, that is, the asymmetrical bidirectional tapered thread 1 of a screw body 31 is an asymmetrical bidirectional tapered external thread 9 in an olive-like shape 93 with two taper structure forms in which a left taper 95 is less than a right taper 96 and the left taper 95 is greater than the right tape 96, wherein a thread section, which is located at the left side of a polish rod 20, that is, a non-thread section, of the screw body 31 is the asymmetrical bidirectional tapered external thread 9 in the olive-like shape 93 in which the left taper 95 is greater than the right tape 96, that is, a thread section, which is in mutual thread fit with a cylindrical body 2, that is, a nut body 21, located at the left side of a workpiece 130, of the external thread 9 is the asymmetrical bidirectional tapered external thread 9 in the olive-like shape 93 in which the left taper 95 is greater than the right tape 96; and a thread section, which is located at the right side of a polish rod 20, that is, a non-thread section, of the screw body 31 is the asymmetrical bidirectional tapered external thread 9 in the olive-like shape 93 in which the left taper 95 is less than the right tape 96, that is, a thread section, which is in mutual thread fit with a cylindrical body 2, that is, a nut body 22, located at the right side of a workpiece 130, of the external thread 9 is the asymmetrical bidirectional tapered external thread 9 in the olive-like shape 93 in which the left taper 95 is less than the right tape 96.

In the present embodiment, the internal thread, that is, an asymmetrical bidirectional tapered internal thread 6 in an olive-like shape 93 in which a left taper 95 is less than a right taper 96, of a cylindrical body 2, that is, a nut body 21, is located at the left side of the workpiece 130, and an asymmetrical bidirectional tapered internal thread 6 in an olive-like shape 93 in which a left taper 95 is greater than a right taper 96, of a cylindrical body 2, that is, a nut body 22, is located at the right side of the workpiece 130. Accordingly, the asymmetrical bidirectional tapered thread 1 in an olive-like shape of the screw body 31 of the columnar body 3 further includes asymmetrical bidirectional tapered external threads 9 in olive-like shapes 93 of two taper structure forms, that is, includes the asymmetrical bidirectional tapered external thread 9 in the olive-like shape 93 in which the left taper 95 is less than the right taper 96 at the left side of the polish rod 20, that is, a non-thread section, of the screw rod 31 and the asymmetrical bidirectional tapered external thread 9 in the olive-like shape 93 in which the left taper 95 is greater than the right taper 96 at the right side of the polish rod 20, that is, a non-thread section, of the screw rod 31, that is, a thread section at the left side of the screw body 31 in which the external thread 9 and the nut body 21 are in mutual thread fit is the asymmetrical bidirectional tapered external thread 9 in the olive-like shape 93 and the left taper 95 is less than the right taper 96; and a thread section at the right side of the screw body 31 in which the external thread 9 and the nut body 22 are in mutual thread fit is the asymmetrical bidirectional tapered external thread 9 in the olive-like shape 93 and the left taper 95 is greater than the right taper 96.

The combination of the bolt and the double nuts depends on the application requirement.

Specific embodiments described herein are exemplary illustrations to the spirit of the present invention. Those skilled in the art to which the present invention pertains may make various modifications or additions to the specific embodiments described or obtain equivalents by using similar alternatives without deviating from the spirit of the present invention or exceeding the scope defined by the appended claims.

Although terms such as tapered thread 1, cylindrical body 2, nut body 21, nut body 22, columnar body 3, polish rod 20, tapered hole 4, bidirectional tapered hole 41, bidirectional tapered hole conical surface 42, first helical conical surface 421 of the tapered hole, first taper angle α1, second helical conical surface 422 of the tapered hole, second taper angle α2, internal helical line 5, internal thread 6, truncated cone body 7, bidirectional truncated cone body 71, bidirectional truncated cone body conical surface 72, first helical conical surface 721 of truncated cone body, first taper angle α1, second helical conical surface 722 of truncated cone body, second taper angle α2, external helical line 8, external thread 9, olive-like shape 93, left taper 95, right taper 96, leftward distribution 97, rightward distribution 98, connection pair for thread and/or thread pair 10, clearance 101, self-locking force, self-locking, self-positioning, pressure, cone axis 01, thread axis 02, mirror image, shaft sleeve, shaft, unidirectional tapered body, bidirectional tapered body, cone, internal cone, tapered hole, external cone, cone, cone pair, helical structure, helical movement, thread body, complete unit thread, concentric force, concentric force angle, anti-concentric force, anti-concentric force angle, centripetal force, anti-centripetal force, reverse collinear, internal stress, bidirectional force, unidirectional force, sliding bearing, sliding bearing pair, locking bearing surface 111, locking bearing surface 112, bearing surface 122 of the tapered thread, bearing surface 121 of the tapered thread, non-entity space, material entity, workpiece 130, non-rigid connection, non-rigid material, transmission member, gasket and so on have been widely used in the present invention, other terms can be used alternatively. These terms are only used to better description and illustration of the essence of the present invention. It departs from the spirit of the present invention to deem it as any limitation of the present invention.

We claim:

1. A connection structure of a bolt and a nut of an asymmetric bidirectional tapered thread in an olive-like shape, comprising an external thread (9) and an internal thread (6) in mutual threaded fit, wherein
a complete unit thread of the asymmetric bidirectional tapered internal thread (6) in the olive-like shape (93) is a helical asymmetric bidirectional tapered body in an olive-like shape (93), with a large middle and two small ends, and with different sizes in a left taper (95) and a right taper (96), the helical asymmetric bidirectional tapered body in the olive-like shape (93) comprises a bidirectional tapered hole (41) and/or a bidirectional truncated cone body (71), and the complete unit thread comprises two taper structure forms in which the left taper (95) is greater than the right taper (96) and the left taper (95) is less than the right taper (96);
a thread body of the internal thread (6) is the helical bidirectional tapered hole (41) in an internal surface of a cylindrical body (2) and exists in the form of a “non-entity space”;
a thread body of the external thread (9) is a helical bidirectional truncated cone body (71) formed on an external surface of a columnar body (3) and exists in the form of a “material entity”;
the left taper (95) formed by a left conical surface of the asymmetrical bidirectional tapered body corresponds to a first taper angle (α1), and the right taper (96) formed by a right conical surface corresponds to a second taper angle (α2);
the left taper (95) and the right taper (96) are opposite in direction and different in taper size;
the internal thread (6) and the external thread (9) are in thread fit to house a cone in the tapered hole until an internal conical surface and an external conical surface mutually bear;
technical performances mainly depend on the conical surfaces and the taper sizes of the screw thread bodies in mutual fit;
the left taper (95) is greater than the right taper (96), preferably, the first taper angle (α1) is greater than 0° and less than 53°, and the second taper angle (α2) is greater than 0° and less than 53°; and for individual special fields, preferably, the first taper angle (α1) is greater than or equal to 53° and less than 180°; and
the left taper (95) is less than the right taper (96), preferably, the first taper angle (α1) is greater than 0° and less than 53°, and the second taper angle (α2) is greater than 0° and less than 53°; and for individual special fields, preferably, the second taper angle (α2) is greater than or equal to 53° and less than 180°.

2. The connection structure according to claim 1, wherein
the bidirectional tapered internal thread (6) in the olive-like shape (93) comprises a left conical surface, that is, a first helical conical surface (421) of the tapered hole, and a right conical surface, that is, a second helical conical surface (422) of the tapered hole of a bidirectional conical surface (42) of the tapered hole, and an internal helical line (5);
a shape formed by the first helical conical surface (421) of the tapered hole and the second helical conical surface (422) of the tapered hole, that is, a bidirectional helical conical surface, is the same as a shape of an external helical lateral surface of a rotary body, wherein the rotary body is formed by two inclined sides of a right-angled trapezoid union when the right-angled trapezoid union axially moves at a constant speed along a central axis of the cylindrical body (2) while circumferentially rotating at a constant speed with right-angled sides of the right-angled trapezoid union as a rotation center, wherein the right-angled trapezoid union is formed by symmetrically and oppositely joining lower bottom sides of two right-angled trapezoids with the same lower bottom sides and the same upper bottom sides but different right-angled sides, wherein the right-angled trapezoids coincide with the central axis of the cylindrical body (2);
the bidirectional tapered external thread (9) in the olive-like shape (93) comprises a left conical surface, that is, a first helical conical surface (721) of the truncated cone body, and a right conical surface, that is, a second helical conical surface (722) of the truncated cone body of a bidirectional conical surface (72) of the truncated cone body, and an external helical line (5); and
a shape formed by the first helical conical surface (721) of the truncated cone body and the second helical conical surface (722) of the truncated cone body, that is, a bidirectional helical conical surface, is the same as a shape of an external helical lateral surface of a rotary body, wherein the rotary body is formed by two inclined sides of a right-angled trapezoid union when the right-angled trapezoid union axially moves at a constant speed along a central axis of the columnar body (3) while circumferentially rotating at a constant speed with right-angled sides of the right-angled trapezoid union as a rotation center, wherein the right-angled trapezoid union is formed by symmetrically and oppositely joining lower bottom sides of two right-angled trapezoids with the same lower bottom sides and the same upper bottom sides but different right-angled sides, wherein the right-angled trapezoids coincide with the central axis of the columnar body (3).

3. The connection structure according to claim 2, wherein when the right-angled trapezoid union makes one revolution at a constant speed, a distance that the right-angled trapezoid union axially moves is equal to at least one times the sum of the lengths of right-angled sides of the two right-angled trapezoids.

4. The connection structure according to claim 2, wherein when the right-angled trapezoid union makes one revolution at a constant speed, a distance that the right-angled trapezoid union axially moves is equal to the sum of the lengths of right-angled sides of the two right-angled trapezoids.

5. The connection structure according to claim 1, wherein the left conical surface and the right conical surface, that is, the first helical conical surface (421) of the tapered hole and the second helical conical surface (422) of the tapered hole, and the internal helical line (5) of the bidirectional tapered body are both continuous helical surfaces or non-continuous helical surfaces; and the first helical conical surface (721) of the truncated cone body and the second helical conical surface (722) of the truncated cone body, and the external helical line (8) are all continuous helical surfaces or non-continuous helical surfaces.

6. The connection structure according to claim 1, wherein
the internal thread (6) is formed by symmetrically and oppositely joining lower bottom surfaces of two tapered holes (7) with the same lower bottom surfaces and the upper top surfaces and different cone heights, and upper top surfaces are disposed on two ends of the bidirectional tapered hole (41) to form an asymmetric bidirectional tapered thread (1) in the olive-like shape (93), and the process comprises that the upper top surfaces are respectively fitted with upper top surfaces of adjacent bidirectional tapered holes (41) and/or respectively fitted with upper top surfaces of adjacent bidirectional tapered holes (41) in a helical form so as to form the asymmetric bidirectional tapered internal thread (6) in the olive-like shape (93);
the external thread (9) is formed by symmetrically and oppositely joining lower bottom surfaces of two truncated cone bodies (7) with the same lower bottom surfaces and the upper top surfaces and different cone heights, and upper top surfaces are disposed on two ends of the bidirectional truncated cone bodies (71) to form the asymmetric bidirectional tapered thread (1) in the olive-like shape (93), and the process comprises that the upper top surfaces are respectively fitted with upper top surfaces of adjacent bidirectional truncated cone bodies (71) and/or respectively fitted with upper top surfaces of adjacent bidirectional truncated cone bodies (71) in a helical form so as to form the asymmetric bidirectional tapered external thread (9) in the olive-like shape (93).

7. The connection structure according to claim 1, wherein the internal thread (6) and the external thread (9) form a thread pair (10) in such a way that the first helical conical surface (421) of the tapered hole and the second helical conical surface (422) of the tapered hole as well as the first helical conical surface (721) of the truncated cone body and the second helical conical surface (722) of the truncated cone body achieve that internal and external diameters of an internal cone and an external cone are centralized by taking a contact surface as a bearing surface under the guidance of the helical line until the bidirectional tapered hole conical surface (42) and the bidirectional truncated cone body conical surface (72) are cohered to achieve load bearing in one direction of the helical conical surface and/or simultaneous load bearing in both directions of the helical conical surface and/or until the sizing self-positioning contact and/or until the sizing interference contact to achieve self-locking.

8. The connection structure according to claim 1, wherein
a screw body (31) of the columnar body (3) is provided with one and/or two asymmetrical bidirectional tapered threads (1) in olive-like shapes (93) comprising an asymmetrical bidirectional tapered external thread (9) in an olive-like shape in which the left taper (95) is greater than the right taper (96) and/or an asymmetrical bidirectional tapered external thread (9) in an olive-like shape in which the left taper (95) is less than the right taper (96);
when a connecting hole of the cylindrical body (2) is screwed into a screwing end of the columnar body (3), there is a requirement for a screwing direction, that is, the connecting hole of the cylindrical body (2) can not be screwed reversely, and the connecting hole is a threaded hole provided in a nut (21) and a nut (22), and the connecting hole is disposed within the nut (21) and the nut (22);
the nut refers to an object comprising a nut in which a threaded structure is disposed on an internal surface of the cylindrical body (2);
when a single nut and/or double nuts and/or a plurality of nuts of the asymmetrical bidirectional tapered internal thread (6) in the olive-like shape and the asymmetrical bidirectional tapered external thread (9) in the olive-like shape of the screw body (31) of the columnar body (3) are in mutual thread fit, a screw thread of the cylindrical body (2) comprises one and/or two asymmetrical bidirectional tapered threads (1) in olive-like shapes (93) comprising an asymmetrical bidirectional tapered internal thread (6) in an olive-like shape in which the left taper (95) is greater than the right taper (96) and/or an asymmetrical bidirectional tapered internal thread (6) in an olive-like shape in which the left taper (95) is less than the right taper (96).

9. The connection structure according to claim 8, wherein when one nut has been effectively cohered with a bolt together, that is, the internal thread (6) and the external thread (9) forming a tapered thread connection pair (10) are effectively cohered together, an additional nut may be removed or retained, the removed nut is only used as a mounting process nut, an internal thread of the mounting process nut comprises a traditional screw thread comprising a bidirectional tapered thread (1), a unidirectional tapered thread as well as a triangular thread, a trapezoidal thread, a sawtooth thread, a rectangular thread, an arc thread and other geometric threads capable of conforming to the technical spirit of the present invention only when the thread body is in mutual thread fit with the bidirectional tapered external thread (9).

10. The connection structure according to claim 1, wherein the internal thread (6) and/or the external thread (9) comprise and/or comprises that a single-pitch thread body is an incomplete tapered geometry, that is, the single-pitch thread body is an incomplete unit thread.
